(19) United States
(12) Patent Application Publication
(10) Pub. No.: US 2014/0153294 A1
(43) Pub. Date: Jun. 5, 2014

(54) AC/DC Power Converter Arrangement

(71) Applicant: INFINEON TECHNOLOGIES AUSTRIA AG, Villach (AT)

(72) Inventors: Gerald Deboy, Klagenfurt (AT); Yi Tang, Singapore (SG)

(73) Assignee: Infineon Technologies Austria AG, Villach (AT)

(21) Appl. No.: 13/706,137

(22) Filed: Dec. 5, 2012

(51) Int. Cl. H02M 3/335

(52) U.S. Cl. CPC H02M 3/33569
USPC 363/21.04

(57) ABSTRACT

A converter arrangement, includes a DC/DC stage comprising a plurality of DC/DC converters. Each of the plurality of DC/DC converters is operable to receive one of a plurality of direct input voltages. The DC/DC stage is configured to generate an output voltage from the plurality of direct input voltages.

### TECHNICAL FIELD

Embodiments of the present invention relate to a power converter arrangement.

### BACKGROUND

While conventional power grids provide an AC voltage, such as an 220V_{RMS} or an 110V_{RMS} voltage, many industrial electronics, communication electronics, consumer electronics, or computer applications require a DC supply voltage. Conventional power converter arrangements for converting an AC voltage into a DC voltage include an AC/DC converter that converts the AC voltage into a first DC voltage (usually referred to as DC link voltage), and a DC/DC converter that converts the first DC voltage into a second DC voltage with an amplitude as required by the specific application.

Usually, the AC/DC converter is implemented as a switched-mode converter that includes at least one power transistor. The power transistor has a voltage blocking capability that is high enough to withstand the DC link voltage. In conventional AC/DC converter arrangements, the DC link voltage is between about 400V and 420V, and the voltage blocking capability of the power transistor is between about 600V and 650V. Losses (conduction losses) occur when the power transistor is in an on-state. These losses are dependent on the amplitude of the input voltage of the AC/DC converter and are inversely proportional to the input voltage raised to the third power.

There is a need to provide an AC/DC converter arrangement that has low losses.

### SUMMARY OF THE INVENTION

A first embodiment relates to a converter arrangement. The converter arrangement includes a DC/DC stage including a plurality of DC/DC converters, wherein each of the plurality of DC/DC converters is operable to receive one of a plurality of direct input voltages, and wherein the DC/DC stage is configured to generate an output voltage from the plurality of direct input voltages.

A second embodiment relates to a method. The method includes receiving one of a plurality of direct input voltages by each of a plurality of DC/DC converters of a DC/DC stage, and generating, by the DC/DC stage, an output voltage from the plurality of direct input voltages.

A third embodiment relates a converter arrangement. The converter arrangement includes means for receiving one of a plurality of substantially direct input voltages by each of a plurality of DC/DC converters of a DC/DC stage and means for generating, by the DC/DC stage, an output voltage from the plurality of direct input voltages.

### BRIEF DESCRIPTION OF THE DRAWINGS

Examples will now be explained with reference to the drawings. The drawings serve to illustrate the basic principle, so that only aspects necessary for understanding the basic principle are illustrated. The drawings are not to scale. In the drawings the same reference characters denote like features.

FIG. 1 illustrates a first embodiment of an AC/DC power converter arrangement with a plurality of AC/DC converters connected in series between input terminals, and with a plurality of DC/DC converters that have their outputs connected in parallel;

FIG. 2 illustrates one embodiment of an AC/DC converter and a DC/DC converter coupled to the AC/DC converter;

FIG. 3 illustrates one embodiment of a control circuit of a master AC/DC converter;

FIG. 4 illustrates an embodiment of a control circuit of a master DC/DC converter;

FIG. 5 illustrates one embodiment of a control circuit of a slave AC/DC converter;

FIG. 6 illustrates one embodiment of a control circuit of a slave DC/DC converter;

FIG. 7 illustrates a further embodiment of an AC/DC converter;

FIG. 8 illustrates a second embodiment of an AC/DC converter arrangement, wherein the arrangement includes one rectifier circuit connected between the input terminals and the series circuit with the AC/DC converters;

FIG. 9 illustrates a third embodiment of an AC/DC converter arrangement, wherein the arrangement includes one AC/DC converter connected between the input terminals and the plurality of DC/DC converters;

FIG. 10 illustrates a second embodiment of a DC/DC converter;

FIG. 11 illustrates a third embodiment of a DC/DC converter;

FIG. 12 illustrates a fourth embodiment of a DC/DC converter;

FIG. 13 illustrates a fourth embodiment of an AC/DC power converter arrangement, the arrangement including a plurality of AC/DC converters connected in series between input terminals, and a plurality of DC/DC converters that share one rectifier circuit;

FIG. 14 illustrates one AC/DC converter arrangement in accordance with the embodiment of FIG. 13 in greater detail;

FIG. 15 illustrates one embodiment for implementing first switches illustrated in FIG. 14;

FIG. 16 illustrates one embodiment for implementing second switches illustrated in FIG. 14;

FIG. 17, which includes FIGS. 17A and 17B, shows timing diagrams illustrating the operating principle of the AC/DC converter arrangement of FIG. 14;

FIG. 18 illustrates a further embodiment for implementing the switching circuits in the circuit arrangement of FIG. 14;

FIG. 19 illustrates a fifth embodiment of an AC/DC power converter arrangement with a plurality of AC/DC converters connected in series between input terminals, and with two groups of DC/DC converters each sharing one rectifier circuit;

FIG. 20 illustrates a sixth embodiment of an AC/DC power converter arrangement with a plurality of AC/DC, and with a plurality of DC/DC converters;

FIG. 21 illustrates a seventh embodiment of an AC/DC power converter arrangement with a plurality of AC/DC, and with a plurality of DC/DC converters;

FIG. 22 illustrates an eighth embodiment of an AC/DC power converter arrangement with a plurality of AC/DC, and with a plurality of DC/DC converters; and

FIG. 23 illustrates a ninth embodiment of an AC/DC power converter arrangement with a plurality of AC/DC, and with a plurality of DC/DC converters.

In the following detailed description, reference is made to the accompanying drawings, which form a part thereof, and in which is shown by way of illustration specific embodiments in which the invention may be practiced.

### DETAILED DESCRIPTION OF ILLUSTRATIVE EMBODIMENTS

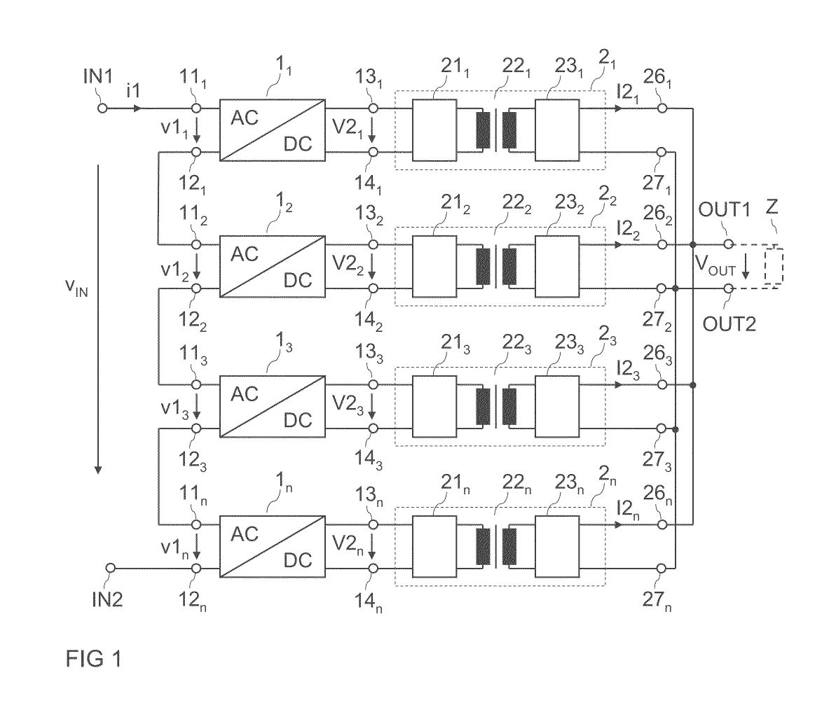

FIG. 1 illustrates a first embodiment of an AC/DC converter arrangement that is configured to convert an alternating input voltage v_{IN} into a substantially direct output voltage V_{OUT}. In the following, the alternating input voltage v_{IN} will be referred to as AC input voltage, and the direct output voltage V_{OUT} will be referred to as DC output voltage. Further, upper case letters V, I denote DC voltages and DC currents, respectively, while lower case letter v, i denote AC voltages and AC currents, respectively. The input voltage v_{IN} is, for example, an AC grid voltage. This AC grid voltage may vary between 270V_{RMS} and 85V_{RMS} (380V_{MAX} and 120V_{MAX}) dependent on the country where the AC grid is implemented. The output voltage V_{OUT} may serve to supply any kind of DC load Z (illustrated in dashed lines in FIG. 1). The amplitude of the output voltage V_{OUT} is dependent on the load requirements and may vary, for example, between 1V and 50V.

Referring to FIG. 1, the AC/DC power converter arrangement includes a plurality of n (with n≧2) AC/DC converters 1₁, 1₂, 1₃, 1ₙ that are connected in series between input terminals IN1, IN2. The input voltage v_{IN} is available between the input terminals IN1, IN2. In FIG. 1, like features of the individual AC/DC converters 1₁-1ₙ have like reference characters with different subscript indices. For example, features of the first DC/DC converter 1₁ have the subscript index “1,” features of a second DC/DC converter 1₂ have a subscript index “2,” and so on. In the following description, when explanations equivalently apply to each of the AC/DC converters 1₁-1ₙ, reference characters are used without index.

Referring to FIG. 1, each AC/DC converter 1 has input terminals 11, 12 for receiving an AC input voltage v1, and output terminals 13, 14 for providing a substantially direct output voltage (DC output voltage) V2. The DC output voltages V2 of the individual AC/DC converters 1 will be referred to as DC link voltages in the following. The individual AC/DC converters 1 are connected in series between the input terminals IN1, IN2, so that the input voltages v1 of the individual AC/DC converters 1 are a share of the AC input voltage v_{IN} of the power converter arrangement. The individual AC/DC converters 1 have their input terminals interconnected such that a first AC/DC converter 1₁ has a first input terminal 11₁ connected to the first input terminal IN1 of the power converter arrangement, and that an n-th AC/DC converter 1ₙ has a second input terminal 12ₙ connected to the second input terminal IN2 of the power converter arrangement. Each of the other AC/DC converters has the first input terminal 11 connected to the second input terminal 12 of one other AC/DC converter, so that the individual AC/DC converters 1 are connected in series (are cascaded) between the input terminals IN1, IN2.

In the embodiment of FIG. 1, the power converter arrangement includes n=4 AC/DC converters 1. However, this is only an example. The number n, with n≧2, of AC/DC converters 1 can be selected arbitrarily dependent on the specific application. According to one embodiment (not illustrated), only n=2 AC/DC converters are connected in series between the input terminals IN1, IN2. The arrangement with the plurality of AC/DC converters will be referred to as AC/DC stage of the AC/DC converter arrangement in the following.

Referring to FIG. 1, the power converter arrangement further includes a plurality of DC/DC converters that generate the output voltage V_{OUT} from the DC link voltages V2 of the individual AC/DC converters 1. In the embodiment of FIG. 1, the power converter arrangement includes n DC/DC converters 2₁-2ₙ. Like features of the individual DC/DC converters 2₁, 2ₙ have like reference characters that have different subscript indices. Each DC/DC converter 2 receives the DC link voltage V2 from one AC/DC converter 1. The individual DC/DC converters 2 each have a first output terminal 26 connected to the first output terminal OUT1 of the power converter arrangement, and a second output terminal 27 connected to the second output terminal OUT2 of the power converter arrangement, so that the individual DC/DC converters 2 have their outputs connected in parallel. The arrangement with the plurality of DC/DC converters will be referred to as DC/DC stage of the AC/DC converter arrangement in the following.

Referring to FIG. 1, each DC/DC converter 2 includes a transformer 22 with a primary winding connected to a switching circuit 21, and a secondary winding connected to a rectifier circuit 23. The switching circuit 21 of each DC/DC converter 2 receives the DC link voltage V2 from the corresponding AC/DC converter 1 and is configured to generate a pulse-width modulated (PWM) voltage from the DC link voltage V2 at the primary winding. The rectifier circuit 23 of each DC/DC converter 2 receives the PWM voltage from the transformer 22 and is configured to rectify the PWM voltage in order to provide a DC output current 12 and the DC output voltage V_{OUT}.

In the AC/DC power converter arrangement of FIG. 1, the input voltages v1 of the individual AC/DC converters 1 are a share of the input voltage v_{IN} of the AC/DC power converter arrangement so that the individual AC/DC converters 1 can be implemented with transistors having lower voltage blocking capabilities than a transistor that would be required in a power converter arrangement with only one AC/DC converter. In general, the on-resistance R_{DSon} of a power transistor is approximately proportional to Vmax^{2,5}, where Vmax is the voltage blocking capability of the power transistor. Thus, although at least n power transistors are required in the power converter arrangement of FIG. 1, namely at least one power transistor in each AC/DC converter, the overall conduction losses in the plurality of AC/DC converters 1₁-1ₙ are lower than comparable conduction losses in an implementation with only one AC/DC converter.

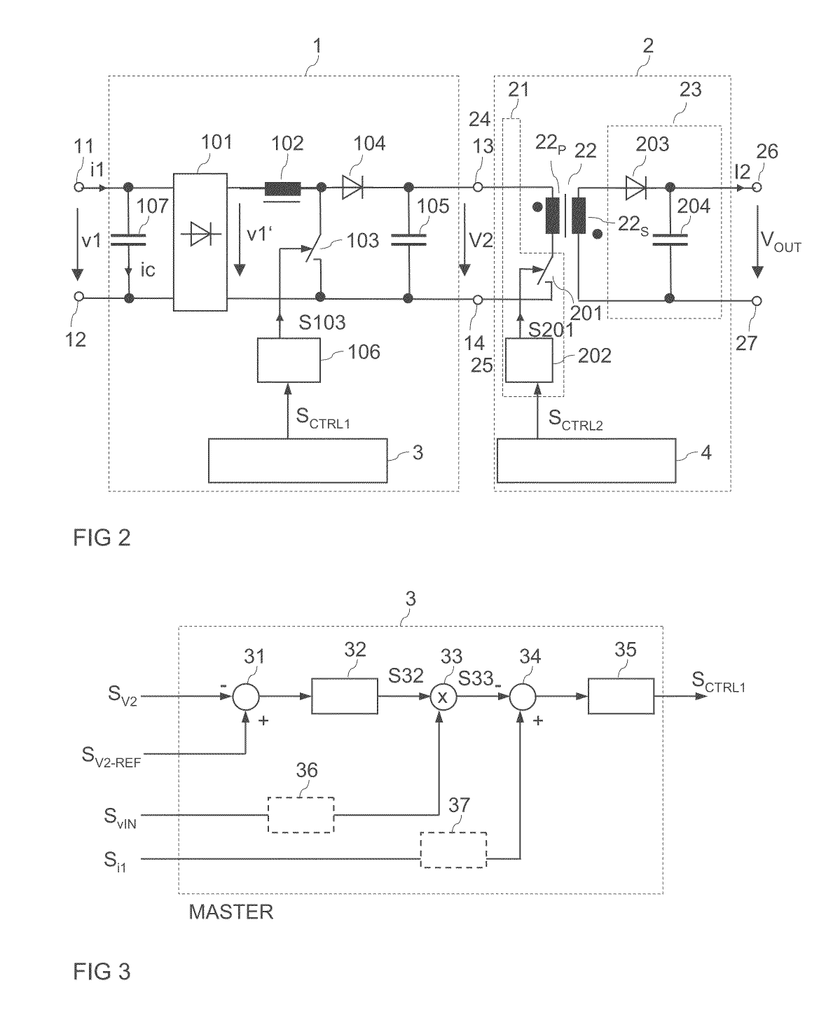

The AC/DC converters 1 and the DC/DC converters 2 can be implemented in accordance with conventional AC/DC converter topologies and DC/DC converter topologies, respectively. FIG. 2 illustrates an AC/DC converter 1 according to one embodiment, and a DC/DC converter 2 connected to the AC/DC converter 1 according to one embodiment. In the following, a circuit with one AC/DC converter and with one DC/DC converter connected to the AC/DC converter will be referred to as AC/DC converter unit. For example, the AC/DC converter 1₁ and the corresponding DC/DC converter 2₁ form one AC/DC converter unit (in general AC/DC converter 1ᵢ, with i being one of 1 to n, and corresponding DC/DC converter 2, form one AC/DC converter unit).

The individual AC/DC converter units of the power converter arrangement may have identical topologies. That is, each of the power AC/DC converter units of FIG. 1 may be implemented as explained with reference to FIG. 2, or may be implemented as explained with reference to other drawings herein below.

The AC/DC converter 1 of FIG. 2 is implemented as a boost converter that is configured to generate the DC link voltage V2 from the AC input voltage v1 of the AC/DC converter 1. The amplitude of the DC link voltage V2 is equal to or higher than the peak voltage of the AC input voltage v1. However, the DC link voltage V2 is lower than the peak value of the overall input voltage v_{IN}, and a ratio between the DC link voltage V2 and the output voltage V_{OUT} is lower than a ratio between the peak voltage of the overall input voltage v_{IN}, and the output voltage, so that the transformers 22 in the individual DC/DC converters 2 can be implemented with a lower winding ratio than a transformer in a system with only one AC/DC converter and only one DC/DC converter. Such transformers with a lower winding ratio are easier to design and have lower leakage inductances than a transformer with a higher winding ratio.

Referring to FIG. 2, the AC/DC converter 1 includes a rectifier circuit 101, such as a bridge rectifier, that generates a rectified input voltage v1′ from the AC input voltage v1. In case the AC input voltage v1 has a sinusoidal waveform, the waveform of the rectified input voltage v1′ is the waveform of a rectified sinusoidal signal. An input capacitor 107 is connected between the input terminals 11, 12 of the AC/DC converter 1. The AC/DC converter 1 further includes a series circuit with an inductive storage element 102, such as a choke, and a switching element 103. This series circuit is connected to outputs of the bridge rectifier 101 and receives the rectified input voltage v1′. Further, a series circuit with a rectifier element 104 and an output capacitor 105 is connected in parallel with the switching element 103. The output capacitor 105 is connected between the output terminals 13, 14 of the AC/DC converter 1 and provides the DC link voltage V2.

The rectifier element 104 may be implemented as a passive rectifier element, such as a diode (as illustrated). However, it is also possible to implement the rectifier element 104 as an active rectifier element (synchronous rectifier element). Such an active rectifier element may be implemented using a MOSFET. The implementation of a rectifier element using a MOSFET is commonly known, so that no further explanations are required in this regard. Each of the rectifier elements explained in the following may be implemented as either a passive rectifier element (as illustrated in the drawings) or as an active rectifier element.

Referring to FIG. 2, the AC/DC converter 1 further includes a drive circuit 106 that is operable to generate a pulse-width modulated (PWM) drive signal S103 for the switching element 103. The switching element 103 switches on and off in accordance with the PWM drive signal. The switching element 103, like any other switching element explained in the following, may be implemented as a conventional electronic switch, such as a MOSFET (Metal-Oxide-Semiconductor Field-Effect Transistor), an IGBT (Insulated Gate Bipolar Transistor), a BJT (Bipolar Junction Transistor), a JFET (Junction Field-Effect Transistor), a HEMT (High-Electron-Mobility Transistor), or the like. The drive circuit 106 receives a control signal S_{CTRL1} from a first control circuit (controller) 3. This first control circuit 3 will be referred to as AC/DC controller 3 in the following. The first control signal S_{CTRL1} defines the duty cycle of the PWM drive signal S103. The drive circuit 106 is operable to generate the PWM drive signal S103 in accordance with the first control signal S_{CTRL1}. The AC/DC controller 3 receives at least one input signal that represents at least one operation parameter of the AC/DC converter 1. However, this input signal is not illustrated in FIG. 2 and will be explained with reference to further drawings below.

The basic operating principle of the AC/DC converter 1 is as follows. The switching element is driven in a PWM fashion. That is, the switching element is cyclically switched on and off, wherein in each switching cycle, the switching element 103 is switched on for an on-period and is subsequently switched off for an off-period. A duty-cycle of the switching operation is the relationship between the duration of one on-period and the duration of one switching cycle (the duration of the on-period plus the duration of the off-period). According to one embodiment, the switching element 103 is switched on with a fixed frequency so that the durations of the individual switching cycles are constant, while the duration of the on-periods may vary dependent on the control signal S_{CTRL1}.

Each time the switching element 103 switches on, energy is magnetically stored in the inductive storage element 102. The energy stored in the inductive storage element is dependent on the inductance of the inductive storage element and the square of the peak current through the inductive storage element in each switching cycle. When the switching element 103 switches off, the energy stored in the inductive storage element 102 is transferred into the output capacitor 105 via the rectifier element 104. Dependent on the specific implementation of the AC/DC controller 3, one or more of the operation parameters of the AC/DC converter 1 can be regulated by suitably adjusting the duty cycle. This is explained in further detail with reference to FIGS. 3 and 5 below.

The DC/DC converter 2 of FIG. 2 is implemented as flyback converter. Referring to FIG. 2, the switching circuit 21 of the DC/DC converter 2 includes a switching element 201 connected in series with the primary winding 22_{P} of the transformer 22. The series circuit with the primary winding 22_{P} and the switching element 201 is connected between input terminals 24, 25 of the DC/DC converter 2. The input terminals 24, 25 of the DC/DC converter 2 correspond to the output terminals 13, 14 of the AC/DC converter 1 where the DC link voltage V2 is available. The rectifier circuit 23 that is connected to the secondary winding 22_{S} of the transformer 22 includes a series circuit with a rectifier element 203 and an output capacitor 204. The output capacitor 204 is connected between the output terminals 26, 27 of the DC/DC converter 2.

Referring to FIG. 2, the DC/DC converter 2 further includes a drive circuit 202 that is operable to generate a PWM drive signal S201 for the switching element 201. The drive circuit 202 receives a second control signal S_{CTRL2} from a second control circuit 4. The second control circuit 4 of the DC/DC converter 2 will be referred to as DC/DC controller 4 in the following and, therefore defines the duty cycle of PWM voltage applied to the primary winding 22_{P}. The second control signal S_{CTRL2} defines the duty cycle of the PWM drive signal S201. The drive circuit 202 is operable to generate the PWM drive signal S201 with a duty cycle as defined by the control signal S_{CTRL2} Like the switching element of the AC/DC converter 1, the switching element 201 of the DC/DC converter may be switched on with a fixed frequency, wherein the duration of the on-period (the duty cycle) may vary dependent on the second control signal S_{CTRL2}.

The DC/DC controller 4 receives at least one input signal representing at least one operation parameter of the DC/DC converter 2. However, this input signal is not illustrated in FIG. 2, but will be explained with reference to further drawings herein below.

The basic operating principle of the DC/DC converter 2 is as follows. Each time the switching element 201 is switched on, energy is magnetically stored in the air gap of the transformer 22. The primary winding 22_{P} and the secondary winding 22_{S} have opposite winding senses, so that a current through the secondary winding 22_{S} is zero when the switching element 201 is switched on. When the switching element 201 switches off, the energy stored in the transformer 22 is transferred to the secondary winding 22_{S} and causes a current from the secondary winding 22_{S} via the rectifier element 203 to the output capacitor 204 of the rectifier circuit 23. Dependent on the specific type of DC/DC controller 4, at least one of the operation parameters of DC/DC converter 2 can be adjusted. This is explained in further detail herein below.

The individual AC/DC converters 1 of the power converter arrangement may have identical topologies. Further, the individual DC/DC converters 2 of the power converter arrangement may have identical topologies. However, the individual AC/DC converters 1 may include different AC/DC controllers 3, and the individual DC/DC controllers 2 may include different DC/DC controllers 4. According to one embodiment, one power converter unit with one AC/DC converter 1 and one DC/DC converter 2 acts as a master power converter unit, while the other power converter units act as slave power converter units. The AC/DC converter of the master power converter unit will be referred to as master AC/DC converter 1, and the DC/DC converter of the master power converter unit will be referred to as master DC/DC converter. Consequently, the other AC/DC converters will be referred to as slave AC/DC converters, and the other DC/DC converters will be referred to as slave DC/DC converters in the following. For example, the AC/DC converter 1₁ is a master AC/DC converter and the DC/DC converter 2₁ connected thereto is a master DC/DC converter, while the AC/DC converters 1₂-1ₙ are slave AC/DC converters, and the DC/DC converter 2₂-2ₙ are slave DC/DC converters.

The master AC/DC converter has an AC/DC controller 3 that is different from the AC/DC controllers 3 of the slave AC/DC converters, and the master DC/DC converter has a DC/DC controller 4 that is different from the DC/DC controllers 4 of the slave DC/DC converters 2. The AC/DC controller of the master AC/DC converter will be referred to as master AC/DC controller in the following, the AC/DC controllers of the slave AC/DC converters will be referred to as slave AC/DC controllers, the DC/DC controller of the master DC/DC converter will be referred to as master DC/DC controller, and the DC/DC controllers of the slave DC/DC converters will be referred to as slave DC/DC controllers in the following.

FIG. 3 illustrates one embodiment of a master AC/DC controller 3. This AC/DC controller 3 is configured to generate the first control signal S_{CTRL1} such that an input current i1 of the master AC/DC converter is controlled to be in phase with the input voltage v_{IN}, or that there is a predefined phase difference between the input current i1 and the input voltage v_{IN}, and such that the DC link voltage V2 of the master AC/DC converter is regulated to have a predefined set value. By virtue of having the AC/DC converters 1₁-1ₙ connected in series between the input terminals IN1, IN2 the input current i1 of the individual AC/DC converters 1 is identical, so that the master AC/DC converter 1 controls the common input current Il of the individual AC/DC converters 1.

Referring to FIG. 3, the master AC/DC controller 3 receives a DC link voltage signal S_{V2} representing the DC link voltage V2 of the master AC/DC converter, a DC link voltage reference signal S_{V2-REF} representing the reference value or set value of the DC link voltage V2 of the master DC/DC converter 1, an input voltage signal S_{vIN} representing the input voltage V_{IN} of the power converter arrangement, and an input current signal Sᵢ₁ representing the input current i1 of the master AC/DC converter. Except for the DC link voltage reference signal S_{V2-REF} these input signals represent operation parameters of the master AC/DC converter. The master AC/DC controller 3 generates the first control signal S_{CTRL1} of the master AC/DC converter dependent on these input signals such that the input current i1 and the DC link voltage V2 are controlled (regulated) as explained before.

The master AC/DC controller 3 of FIG. 3 generates a first control signal S32 that is dependent on a difference between the DC link voltage reference signal S_{V2-REF} and the DC link voltage signal S_{V2}. A difference between the DC link voltage reference signal S_{V2-REF} and the DC like voltage signal S_{V2} is calculated by a subtractor 31 that provides a difference signal S31. A filter 32 receives the difference signal S31 and provides the first control signal S32. The filter 32 is, for example, a proportional-integral (PI) filter. A multiplier 33 multiplies the first control signal S32 with the input voltage signal S_{vIN}. A filter constant of the filter 32 is such that the first control signal S32 changes slowly relative to a period of the input voltage v_{IN}. Thus, an output signal S33 of the multiplier 33 can be considered as an AC signal with a frequency defined by the input voltage v_{IN} and with an amplitude defined by the first control signal S32. Optionally, the input voltage signal S_{vIN} is amplified in an optional amplifier 36 before the multiplication.

Referring to FIG. 3, a further subtractor 34 forms the difference between the output signal S33 of the multiplier 33 and the input current signal Sᵢ₁. A further filter 35 receives an output signal S34 from the further subtractor 34. The first control signal S_{CTRL1} is available at the output of the further filter. According to one embodiment, the further filter 35 is a PI filter or a proportional-resonant (PR) filter.

The AC/DC controller 3 of FIG. 3 has two control loops, namely a first control loop that generates the first internal control signal S32 and serves to regulate the DC link voltage V2 to correspond to a reference value as defined by the DC link voltage reference signal S_{V2-REF}, and a second control loop that receives the first internal control signal S32, the input voltage signal S_{vIN} and the input current signal Sᵢ₁ and serves to control the input current i1 to be in phase with the input voltage v_{IN}. Optionally, the further subtractor 34 does not receive the input current signal Sᵢ₁ but receives a phase shifted version of the input current signal Sᵢ₁ from a phase shift circuit 37. In this case, the input current i1 is controlled to have a phase difference as defined by the phase shift circuit 37 relative to the input voltage v_{IN}.

The first control signal S_{CTRL1} provided by the master AC/DC controller 3 defines the duty cycle of the PWM drive signal (S103 in FIG. 2A). For example, the first control signal S_{CTRL1} increases in order to increase the duty cycle when the DC link voltage V2 becomes smaller than DC link voltage reference value, and the first control signal S_{CTRL1} decreases in order to decrease the duty cycle when the DC link voltage V2 becomes larger than DC link voltage reference value.

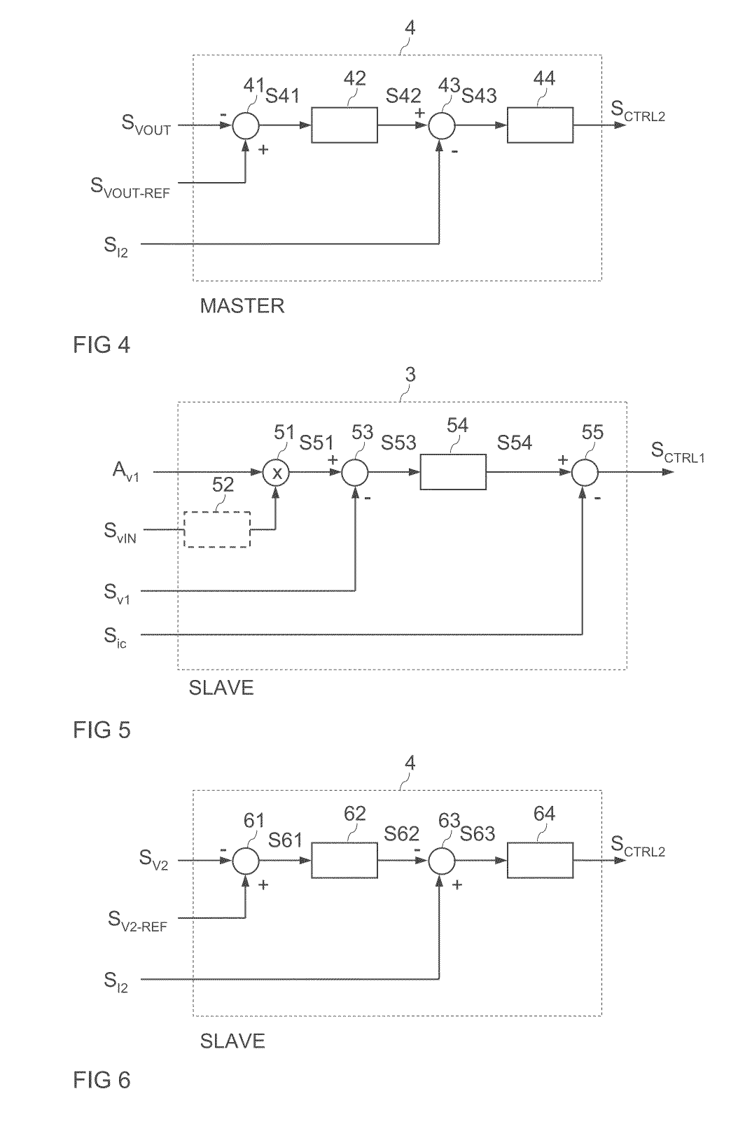

FIG. 4 illustrates an embodiment of a master DC/DC controller 4. This master DC/DC controller 4 operates the master DC/DC converter as a current source that provides a controlled output current (I2 in FIG. 2) such that output voltage V_{OUT} is in correspondence with a predefined output voltage reference value. Referring to FIG. 4, the master DC/DC controller 4 receives an output voltage signal S_{VOUT} representing the output voltage V_{OUT}, an output voltage reference signal S_{Vout-REF} representing the output voltage reference value, and an output current signal S_{I2} representing the output current of the master DC/DC converter. Referring to FIG. 4, the master DC/DC controller 4 generates a first internal control signal S42 that is dependent on a difference between the output voltage signal S_{VOUT} and the output voltage reference signal S_{VOUT-REF}. A first subtractor 41 receives the output voltage reference signal S_{VOUT-REF} and the output voltage signal S_{VOUT} and calculates a difference signal S41. A first filter 42 receives the difference signal S41 and provides the first internal control signal S42. According to one embodiment, the first filter 42 is a PI filter. A second subtractor 42 receives the output current signal S_{I2} and the first internal control signal S42 and calculates a further difference signal S43. A further filter 44 receives the further difference signal S43 and provides the second control signal S_{CTRL2}.

Referring to FIG. 2, the second control signal S_{CTRL2} defines the duty cycle of the PWM drive signal S201 of the switching element 201 in the DC/DC converter 2. In the flyback converter of FIG. 2, the output current 12 of the DC/DC converter 2 increases as the duty cycle of the PWM drive signal 201 increases. In the master DC/DC controller 4 of FIG. 4, the second control signal S_{CTRL2} increases in order to increase the duty cycle of the PWM drive signal S201 and in order to increase the output current 12 when the output voltage V_{OUT} decreases below the reference value as defined by the output voltage reference signal S_{VOUT-REF}. The operating principle of the master DC/DC controller 4 of FIG. 4 is as follows. When the output voltage V_{OUT} decreases, to below the reference value, a difference between the output voltage reference signal S_{VOUT-REF} and the output voltage signal S_{VOUT} increases, and the first control signal S42 increases. An increase of the first internal control signal S42 results in an increase of the further difference signal S43 and the second control signal S_{CTRL2}. An increase of the second control signal S_{CTRL2} results in an increase of the duty cycle of the PWM drive signal S201 and in an increase of the output current I2, so as to counteract the decrease of the output voltage V_{OUT}.

FIG. 5 illustrates an embodiment of one slave AC/DC controller 3. In this embodiment, the slave AC/DC controller 3 generates the first control signal S_{CTRL1} such that the corresponding slave AC/DC converter controls its input voltage to be a predefined share of the input voltage V_{IN} of the power converter arrangement. Referring to FIG. 2, the input voltage v1 of one AC/DC converter 1 can be controlled through a charging/discharging current ic of the input capacitor 107. Consequently, the slave AC/DC controller 4 controls the charging discharging current ic of the input capacitor 107 in order to adjust the input voltage v1 of the corresponding slave AC/DC converter 3.

Referring to FIG. 5, the slave AC/DC controller 3 receives a proportionality factor Aᵥ₁ defining the relationship between the input voltage v1 of the corresponding slave AC/DC converter and the input voltage v_{IN} of the power converter arrangement, an input voltage signal S_{vIN} representing the input voltage v_{IN}, input voltage signal Sᵥ₁ representing the input voltage v1 of the AC/DC converter, and a charging/discharging current signal S_{ic} representing the current through the input capacitor 107. The slave AC/DC controller 3 generates an input voltage reference signal S51 by multiplying the proportionality factor Aᵥ₁ with the input voltage signal S_{vIN}. Optionally, the input voltage signal S_{vIN} is amplified using an amplifier 52 before the multiplication. A first subtractor 53 calculates a difference between the input voltage signal Sᵥ₁ and the reference signal S51. A first filter 54 receives a difference signal S53 from the first subtractor and generates a first internal control signal S54. A further subtractor 55 receives the first internal control signal S54 and the charging/discharging current signal S_{ic}. An output signal of the further subtractor 55 corresponds to the first control signal S_{CTRL1}.

The input voltage v1 that is regulated by the slave AC/DC converter 3 is an AC voltage. The frequency of the AC voltage, however, is small as compared to a switching frequency of the switching element (103 in FIG. 2) of the slave AC/DC converter. The frequency of the overall input voltage v_{IN} is, for example, 50 Hz or 60 Hz, while the switching frequency is in the range of several 10 kHz. Thus, the input voltage signal S_{vIN} representing the overall input voltage v_{IN} and the input voltage signal Sᵥ₁ representing the input voltage v1 of the slave AC/DC converter can be considered constant for a duration of several switching cycles of the switching element 103. Considering this, the operating principle of the slave AC/DC converter 3 of FIG. 5 is as follows. For explanation purposes it is assumed that the instantaneous value of the input voltage v1 decreases below a value as defined by the reference signal S51. In this case, the difference signal S53 increases so that the first control signal S54 increases. An increase of the first control signal S54 results in an increase of the control signal S_{CTRL1} such that the current is into the input capacitor 107 increases in order to increase the instantaneous value of the input voltage v1.

FIG. 6 illustrates an embodiment of a slave DC/DC converter 4. The DC/DC converter 4 of FIG. 6 corresponds to the master DC/DC controller 4 of FIG. 4 with the difference, that the slave DC/DC controller 4 controls the input voltage V2, which is the DC link voltage V2, of the corresponding slave DC/DC converter.

Referring to FIG. 6, a first subtractor 61 receives a DC link voltage reference signal S_{V2-REF} representing a set value of the DC link voltage, a DC link voltage signal S_{V2} representing the DC link voltage and an output current signal S₁₂ representing the output current 12 of the corresponding slave DC/DC converter. A first filter 62 filters a first difference signal S61 provided by the first subtractor 61 and generates a first internal control signal S62. A second subtractor 63 calculates the difference between the output current signal S_{I2} and the first internal control signal S62. A second difference signal S63 provided by the second subtractor 63 is received by a further filter 64. The second control signal S_{CTRL2} is available at the output of the second filter 64. The first and second filters 62, 64 can be conventional filters, such as PI filters.

Referring to FIGS. 2 and 6, the operating principle of the slave DC/DC controller 4 is as follows. When the DC link voltage V2 decreases below the reference value as defined by the DC link voltage reference signal S_{V2-REF}, the first difference signal S61 increases so that the first control signal S62 increases. When the first control signal S62 increases, the further difference signal S63 and the second control signal S_{CTRL2} decreases so as to decrease the duty cycle of the switching element of the corresponding slave DC/DC converter, in order to decrease the input power of the corresponding DC/DC converter.

The operating principle of a power converter arrangement implemented with one master AC/DC converter unit and with n−1 slave power converter units is explained in the following. For explanation purposes, it is assumed that due to variations of the power consumption of a load Z (illustrated in dashed lines in FIG. 1) connected to the output terminals OUT1, OUT2 the output voltage V_{OUT} increases above the predefined set value represented by the output voltage reference signal S_{VOUT-REF} received by the master DC/DC controller 4 (see FIG. 4). In this case, the master DC/DC controller 4 reduces the output current 12 of the master DC/DC converter 4. This results in a reduced input power of the master DC/DC converter. A reduced input power of the master DC/DC converter 2 results in an increase of the DC link voltage of the master power converter unit. The master AC/DC converter 1 then reduces the input current i1 in order to keep the DC link voltage of the master power converter unit approximately constant on a value as defined by the DC link voltage reference signal S_{V2-REF} received by the master AC/DC converter (see FIG. 3). A decrease of the input current i1 results in a decrease of the input power of the slave AC/DC converters, that keep their input voltages v1 constant on a value as defined by the corresponding proportionality factor (Aᵥ₁ in FIG. 5). A decrease of the input power of the slave AC/DC converters also results in a decrease of the input power of the individual slave DC/DC converters, that keep their input voltages (the DC link voltages) constant, so that, consequently, the input currents 12 of the individual slave DC/DC converters decrease. The decrease of the output current 12 of the master DC/DC converter and of the slave DC/DC converters counteract the increase of the input voltage V_{OUT}. In case the output voltage V_{OUT} decreases, the control mechanism explained before results in an increase of the output current 12 of the master DC/DC converter unit and of the slave DC/DC converters.

The proportionality factor Aᵥ₁ defining the input voltages of the individual slave AC/DC converters can be fixed. According to one embodiment, the proportionality factor Aᵥ₁ of each slave AC/DC converter 3 is 1/n, so that the input voltage v1 of each slave AC/DC converter 3 corresponds to (1/n)·v_{IN}. However, it is also possible to have different fixed proportionality factors of the individual slave AC/DC converters 3. According to a further embodiment, the proportionality factors of the individual slave AC/DC converter are dependent on the amplitude of the input voltage v_{IN}. According to one embodiment, the proportionality factor of one or more slave AC/DC converters is set to zero when the amplitude of the input voltage v_{IN} falls below a predefined threshold value. In this way, one or more of the slave AC/DC converters can be switched off at low input voltages v_{IN}.

This operating principle explained before is independent of the specific implementation of the AC/DC converters 1 and the DC/DC converters 2. Just for illustration purposes it has been assumed that the AC/DC converter 1 has the implementation explained with reference to FIGS. 2A and that the DC/DC converters 2 are implemented as flyback converters as illustrated in FIGS. 2A and 2B. However, the individual AC/DC converters 1 can be implemented with other conventional AC/DC converter topologies as well, and the individual DC/DC converters can be implemented with other conventional DC/DC converter topologies as well.

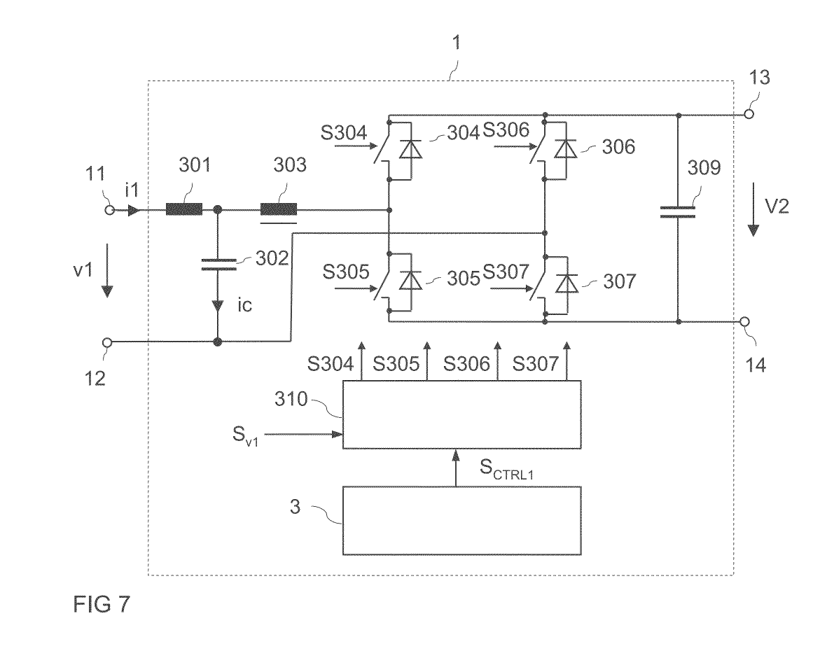

FIG. 7 illustrates an AC/DC converter 1 according to a further embodiment. Referring to FIG. 7 the AC/DC converter 1 includes an input capacitor 302 connected between the input terminals 11, 12. Optionally, an inductive element 301 is connected between the input capacitor 302 and one of the input terminals. The optional inductive element 301 and the input capacitor 302 form an input filter of the AC/DC converter 1. The AC/DC converter 1 of FIG. 7 further includes a full-bridge with a first half-bridge 304, 305 and a second half-bridge 306, 307. Each of the half-bridges is connected in parallel with an output capacitor 309, where the output capacitor 309 is connected between the output terminals 13, 14. An inductive storage element 303 is coupled between a first input terminal 11 and an output of the first half-bridge 304, 305, and an output of the second half-bridge 306, 307 is coupled to the second input terminal 12. Each half-bridge includes two switching elements that have their load paths connected in series, where a circuit node common to the load paths of the switching elements forms the output of the corresponding half-bridge. Referring to FIG. 7, the individual switching elements may include a switch and a rectifier element, such as a diode, connected in parallel to the switch. According to one embodiment, the individual switching elements are implemented as MOSFET, in particular as n-type MOSFET.

A drive circuit 310 receives the first control signal S_{CTRL1} from the AC/DC controller 3 and generates drive signals S304, S305, S306, S307 for the individual switching elements of the half-bridges in accordance with the first control signal S_{CTRL1}. The operating principle of the AC/DC converter 1 of FIG. 7 is explained in the following. Like in the boost converter of FIG. 2, the inductive storage element 303 is operable to store energy in a first time period and to transfer the stored energy to the output capacitor 309 in a second time period. A duty cycle that is defined by the first control signal S_{CTRL1} is defined by the relationship between the duration of the first time period and the sum of the durations of the first and second time periods. The AC/DC converter 1 has two different operation scenarios, namely a first scenario in which input voltage v1 is positive, and a second operation scenario in which the input voltage v1 is negative. According to one embodiment the drive circuit 310 further receives an input voltage signal Sᵥ₁ representing at least the polarity of the input voltage v 1, in order to decide which of the different switches of the full-bridge are to be closed in the first and second time periods. When the input voltage v1 is positive, a low-side switch 305 of the first half-bridge and a low-side switch 307 of the second half-bridge is switched on in the first time period in order to connect the inductive storage element 303 between the input terminals 11, 12. In the second time period the high-side switch 304 of the first half-bridge and the low-side switch 307 of the second half-bridge is switched on in order to transfer the energy stored in the inductive storage element 303 into the output capacitor 309. Thus, the low-side switch 307 of the second half-bridge is permanently switched on when the input voltage v1 is positive, while the switches of the first half-bridge are operated in a pulse-width modulated (PWM) fashion.

When the input voltage v1 is negative, the high-side switch 304 of the first half-bridge and the high-side switch 306 of the second half-bridge switch are switched on in the first time period in order to connect the inductive storage element 303 between the input terminals 11, 12 and in order to store energy in the inductive storage element 303. In the second time period, the high-side switch 306 of the second half-bridge and the low-side switch 305 of the first half-switch are switched on in order to transfer the energy from the inductive storage element 303 into the output capacitor 309. Thus, the high-side switch 306 of the second half-bridge is permanently switched on when the input voltage v1 is negative, while the switches of the first half-bridge are operated in a pulse-width modulated (PWM) fashion.

A variation of the duty-cycle controlled by the first control signal S_{CTRL1} has the same effect as in the boost converter of FIG. 2. The AC/DC controller 3 may be implemented as explained with reference to FIG. 3 when the AC/DC converter 1 of FIG. 7 is in a master AC/DC converter unit, and the AC/DC controller 3 may be implemented as explained with reference to FIG. 5 when the AC/DC converter 1 of FIG. 7 is a slave AC/DC converter.

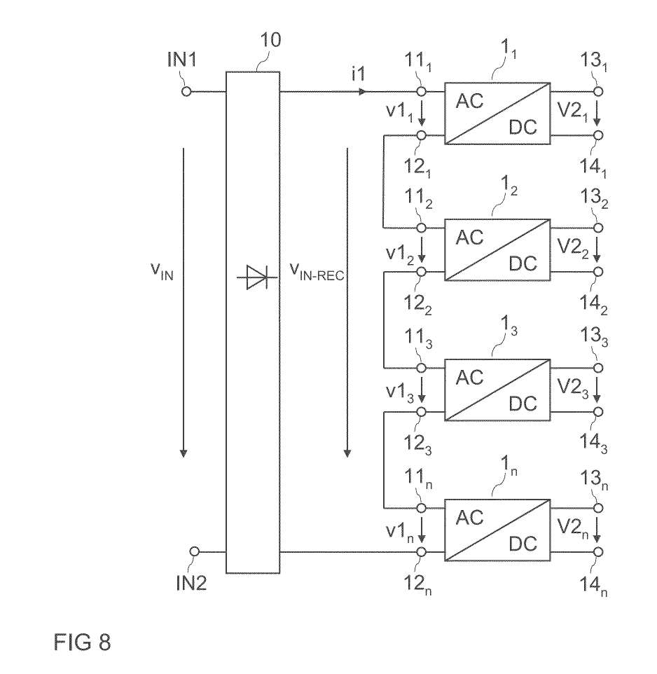

FIG. 8 illustrates the AC/DC stage of an AC/DC converter arrangement according to a further embodiment. The DC/DC stage of the converter arrangement, that is the plurality of DC/DC converters coupled to the AC/DC converters of the AC/DC stage is not illustrated in FIG. 8. These DC/DC converters may correspond to the DC/DC converters explained herein before or to the DC/DC converters explained herein below.

In the AC/DC stage of FIG. 8, one rectifier circuit 10 is connected between the input terminals IN1, IN2 and the series circuit with the converters 1₁-1ₙ. This rectifier circuit 10 receives the input voltage v_{IN} and provides a rectified input voltage v_{IN-REC} from the input voltage v_{IN}. If, e.g., the input voltage v_{IN} has a sinusoidal waveform, the rectified input voltage v_{IN-REC} provided by the rectifier circuit 10 has the waveform of a rectified sinusoidal signal (the absolute value of a sinusoidal signal). The rectifier circuit 10 can be implemented as a conventional bridge rectifier with diodes, synchronous rectifiers, or the like. This type of rectifier is commonly known so that no further explanations are required in this regard. The series circuit with the converters 1₁-1ₙ receives the rectified input voltage v_{IN-REC} and provides the individual DC line voltages V2₁-V2ₙ from the rectified input voltage v_{IN-REC}. The rectified input voltage v_{IN-REC} is a timely varying voltage. If, e.g., the input voltage v_{IN} is a 50 Hz sinusoidal voltage that alternates between a positive and a negative amplitude, the rectified input voltage v_{IN-REC} varies between zero and one of the positive and the negative amplitude and has a frequency of 100 Hz. Thus, the rectified input voltage v_{IN-REC} is not an alternating voltage. Nevertheless, the converters 1₁-1ₙ will be referred to as AC/DC converters in the following. That is, in connection with the present disclosure, an AC/DC converter is a voltage converter that either converts an AC voltage into a DC voltage, or converts a rectified AC voltage into a DC voltage.

If the AC/DC stage is implemented with one central rectifier circuit 10 as illustrated in FIG. 8, the individual AC/DC converters only need to be capable of processing a rectified AC voltage instead of being capable of processing an AC voltage. If, e.g., the AC/DC converters 1₁-1ₙ of FIG. 8 are implemented in accordance with the embodiment explained with reference to FIG. 2, the rectifier circuit 101 in each of the individual AC/DC converters 1 can be omitted when one central rectifier circuit 10 is implemented in the AC stage.

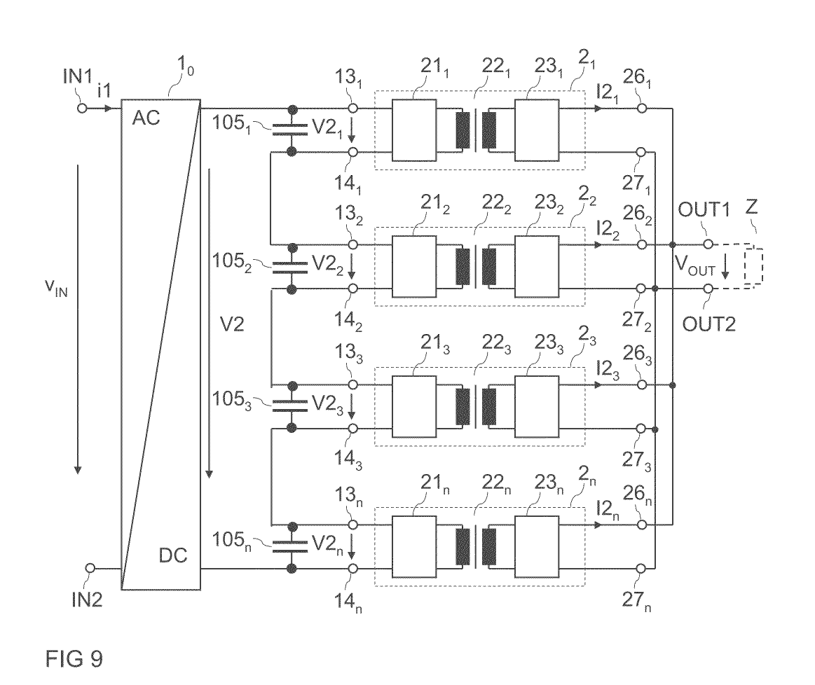

FIG. 9 illustrates a further embodiment of an AC/DC converter arrangement. The AC/DC converter arrangement of FIG. 9 includes one central AC/DC converter 1₀ connected to the input terminals IN1, IN2. The central AC/DC converter 1₀ is configured to generate one DC link voltage V2 from the input voltage v_{IN}. The AC/DC converter 1₀ may be implemented with a converter topology explained with reference to the AC/DC converter 1 in FIG. 2. The difference between the AC/DC converter 1 explained with reference to FIG. 2 and the AC/DC converter 1₀ of FIG. 9 is that the AC/DC converter 1 of FIG. 2 receives an input voltage v1 that is only a share of the overall input voltage v_{IN}, while the AC/DC converter 1₀ of FIG. 9 receives the overall input voltage v_{IN} as an input voltage. Thus, the AC/DC converter 1 of FIG. 2 can be implemented with semiconductor devices having a lower voltage blocking capability than the AC/DC converter 1₀ of FIG. 9.

Referring to FIG. 9, the DC/DC converter 2₁-2ₙ of the DC/DC stage are coupled to the output of the AC/DC converter 1₀ through a capacitive voltage divider. The capacitive voltage divider includes capacitive storage elements 105₁, 105₂, 105₃, 105ₙ connected in series between output terminals of the AC/DC converter 1₀. Each of the DC/DC converters 2 (reference character 2 denotes an arbitrary one of the DC/DC converters 2₁, 2ₙ of FIG. 9) has its input terminals 13, 14 coupled to one of these capacitive storage elements 105₁-105ₙ.

According to one embodiment, the AC/DC converter 1₀ is configured to control the input current i1 received from the input terminals IN1, IN2 such that the input current i1 is in phase with the input voltage v_{IN} or such that there is a predefined phase difference between the input current i1 and the input voltage v_{IN}. Further, the AC/DC converter 1₀ can be configured to control the DC link voltage V2 such that the DC link voltage V2 has a predefined set value.

The operating principle of the DC/DC converters 2₁-2ₙ can correspond to the operating principle explained before. That is, one of the DC/DC converters 2₁-2ₙ may act as a master DC/DC converter that controls the output voltage v_{OUT,} while the other DC/DC converters may act as slave converters that each control the corresponding input voltage, wherein the input voltage of each of the DC/DC converters is a share of the DC link voltage V2, namely the voltage across one of the capacitive storage elements 105₁-105ₙ.

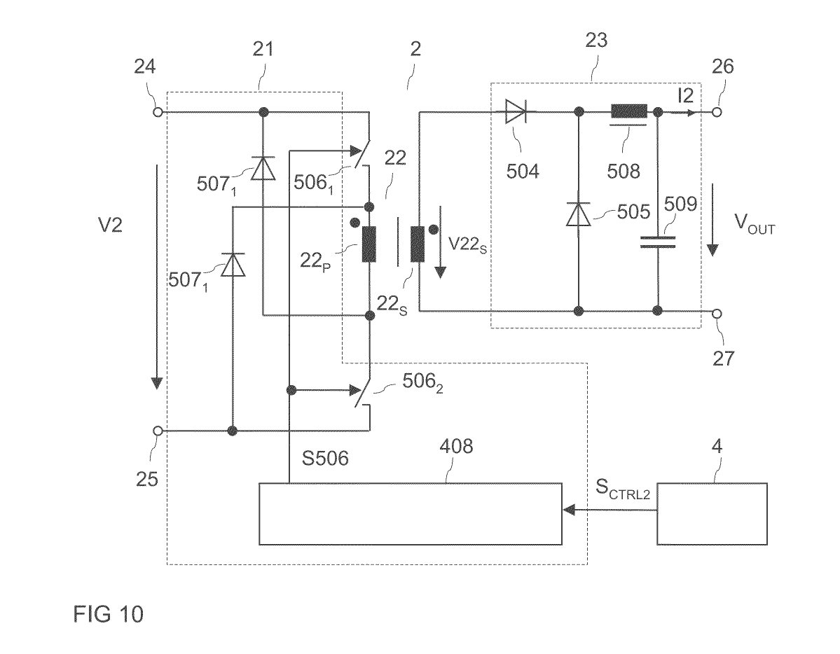

FIG. 10 illustrates a second embodiment of a DC/DC converter 2. The DC/DC converter 2 of FIG. 10 has a two transistor forward (TTF) topology. Referring to FIG. 10, the DC/DC converter 2 includes the transformer 22 with the primary winding 22_{P} and the secondary winding 22_{S}. The primary winding 22_{P} and the secondary winding 22_{S} have identical winding senses in this type of DC/DC converter 2. In the switching circuit 21, the primary winding 22_{P} is connected between a first switch 506₁ and a second switch 506₂, with the series circuit with the switches 506₁, 506₂ and the primary winding 22_{P} connected between the input terminals 24, 25 for receiving the DC link voltage V2. A circuit node common to the first switch 506₁ and the primary winding 22_{P} is coupled to the second input terminal 25 via a first rectifier element 507₁, such as a diode. Further, a circuit node common to the primary winding 22_{P} and the second switch 506₂ is coupled to the first input terminal 24 through a second rectifier element 507₂, such as a diode.

In the rectifier circuit 23, a series circuit with a third rectifier element 504, an inductive storage element 508, and a capacitive storage element 509 is connected in parallel with the secondary winding 22_{S}. The capacitive storage element 509 is connected between the output terminals 26, 27 where the output voltage V_{OUT} is available. A fourth rectifier element 505 is connected in parallel with the series circuit with inductive storage element 508 and the capacitive storage element 509.

Referring to FIG. 10, a drive circuit 510 generates a drive signal S506 to the first and second switches 506₁, 506₂ that are synchronously switched on and switched off. The drive signal S506 is a pulse-width modulated (PWM) drive signal with a duty cycle that is dependent on the second control signal S_{CTRL2} provided by the DC/DC controller 4. The second control signal S_{CTRL2} is dependent on at least one of the operation parameters of the DC/DC converter 2. In a master DC/DC converter, the second control signal S_{CTRL2} may be dependent on the output voltage V_{OUT} and the output current 12, while in a slave DC/DC converter, the second control signal S_{CTRL2} may be dependent on the DC link voltage and the output current 12.

The operating principle of the DC/DC converter 2 of FIG. 10 is as follows. Each time the first and second switches 506₁, 506₂ are switched on, the primary winding 22_{P} is connected between the input terminals 24, 25 and a current flows through the primary winding. The polarity of a voltage V22_{S} across the secondary winding 22_{S} is as indicated in FIG. 10 when the DC link voltage V2 has a polarity as indicated in FIG. 10. This voltage causes a current through the third rectifier element 504, the inductive storage element 508 and the capacitive storage element 509. When the switches 506₁, 506₂ are switched off, the current through the primary winding 22_{P} continuous to flow by virtue of the two rectifier elements 507₁, 507₂. However, the polarity of the voltage V22_{S} across the secondary winding 22_{S} is inverted, so that a current through the first rectifier element 504 becomes zero and a current induced by the inductive storage element 508 flows through the second rectifier element 505 flows. Like in the DC/DC converter explained before, an increase of the duty cycle results in an increase of the input power and an increase of the output current (at a constant output voltage V_{OUT}), respectively.

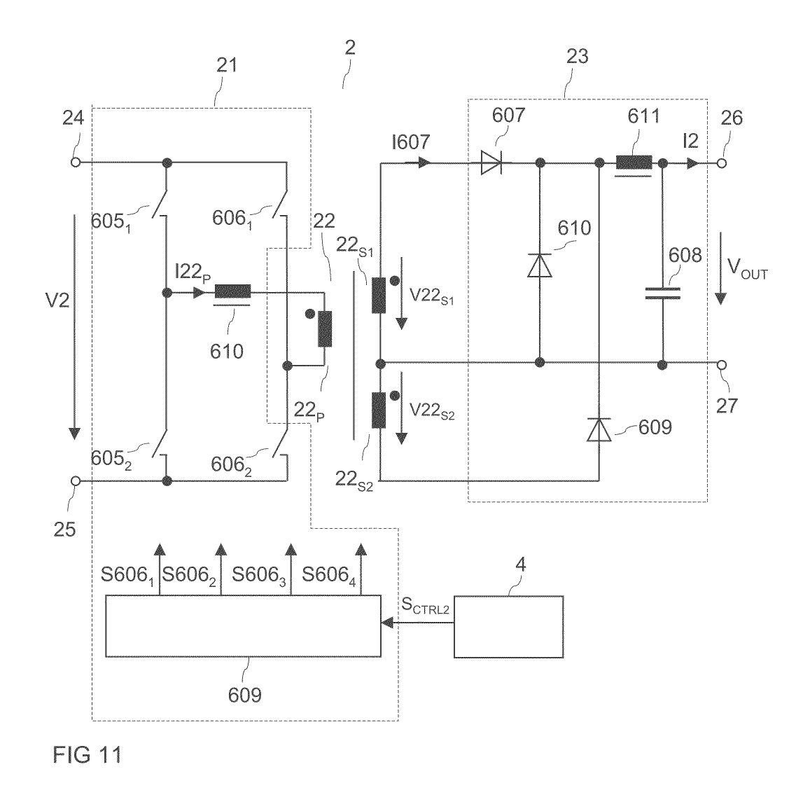

FIG. 11 illustrates an further embodiment of a DC/DC converter 2. The DC/DC converter 2 of FIG. 11 includes a phase-shift zero-voltage switching (ZVS) full bridge topology. Referring to FIG. 11, the switching circuit 21 includes two half bridges each including a high-side switch 605₁, 606₁ and a low-side switch 605₂, 606₂ connected between the input terminals 24, 25 for receiving the DC link voltage V2. A series circuit with an inductive storage element 610 and the primary winding 22_{P} of the transformer 22 is connected between output terminals of the two half bridges. The transformer 22 includes a secondary winding with a center tap resulting in two secondary winding sections 22_{S1}, 22_{S2}. Each of the first and second secondary winding sections 22₅₁, 22_{S2} is inductively coupled with the primary winding 22_{P.} The primary winding 22_{P} and the secondary winding 22_{S1}, 22_{S2} have identical winding senses.

The rectifier circuit 23 includes a series circuit with an inductive storage element 611 and a capacitive storage element 608. The first secondary winding section 22_{S1} is coupled to this series circuit 611, 608, through a first rectifier element 607, and the second first secondary winding section 22_{S2} is coupled to the series circuit 611, 608 through a second rectifier element 609. A third rectifier element 610 is connected in parallel with the series circuit with the inductive storage element 611 and the capacitive storage element 608. Specifically, the inductive storage element 611 is connected to the first secondary winding section 22_{S1} through the first rectifier element 607 and to the second secondary winding section 22_{S2} through the second rectifier element 609. A center tap of the secondary winding 22_{S1}, 22_{S2} is connected to that circuit node of the capacitive storage element 608 facing away from the inductive storage element 611 and to the second output terminal 27, respectively.

The switches 605₁, 605₂, 606₁, 606₂ of the half-bridges are cyclically switched on and off by a drive circuit 609 dependent on the second control signal S_{CTRL2} and in accordance with a specific drive scheme. In FIG. 11, reference characters S605₁, S605₂, S606₁, S606₂ denote drive signals provided by the drive circuit 609 to the individual switches 605₁, 605₂, 606₁, 606₂. Each cycle in accordance with this drive scheme includes four different phases. In a first phase, the high-side switch 605₁ of the first half-bridge and the low-side switch 606₂ of the second half-bridge are switched on. Thus, a current I22_{P} flows through the first inductive storage element 610 and the primary winding 22_{P}. Voltages V22_{S1}, V22_{S2} across the secondary winding sections 22_{S1}, 22_{S2} have polarities as indicated in FIG. 11 when the DC link voltage has a polarity as indicated in FIG. 11. The voltage V22_{S1} across the first secondary winding section 22_{S1} causes a current 1607 through the first rectifier element 607, the second inductive storage element 611 and the capacitive storage element 608, while the second rectifier element 609 blocks.

In a second phase, the high side switch 605₁ of the first half-bridge is switched on and the high-side switch 606₁ of the second half-bridge is switched on. There may be a delay time between switching off the low-side switch 605₂ of the first half-bridge and switching on the high-side switch 606₁ of the second half-bridge. During this delay time, a freewheeling element (not illustrated) connected in parallel with the high-side switch 606₁ may take the current. The switches 605₁, 605₂, 606₁, 606₂ may be implemented as power transistors, in particular as power MOSFETs. Power MOSFETs include an integrated body diode that may act as a freewheeling element.

In the second phase, the voltage across the primary winding 22_{P} and the voltages V22_{S1}, V22_{S2} across the secondary windings 22_{S1}, 22_{S2} are zero. The current through the inductive storage element 611 continuous to flow, where the third rectifier element 610 takes over the current through the inductive storage element 611 and the capacitive storage element 608.

In the third phase, the high-side switch 606₁ of the second half-bridge and the low-side switch 605₂ of the first half-bridge are switched on. The voltages V22_{S1}, V22_{S2} across the secondary winding sections 22_{S1}, 22_{S2} have polarities opposite to the polarities indicated in FIG. 11. In this case, a current flows through the second secondary winding section 22_{S2}, the second rectifier element 609, the inductive storage element 611 and the capacitive storage element 608.

In the fourth phase, the low-side switch 605₂ of the first half-bridge is switched off, and the half-side switch 605₁ of the first half-bridge is switched on. The voltage across the primary winding 22_{P} and the voltages across the secondary winding sections 22_{S1}, 22_{S2} turn to zero. The current through the second inductive storage element 611 and the capacitive storage element 608 continuous to flow, where the third rectifier element 609 provides a current path for this current.

According to one embodiment, a timing of switching on and switching off the individual switches of the two half-bridges is such that at least some of the switches are switched on and/or switched off when the voltage across the respective switch is zero.

Like in the DC/DC converters explained before, the output current 12 can be controlled in order to regulate the output voltage (in a master DC/DC converter), or in order to regulate the DC link voltage (in a slave DC/DC converter). The output current can be regulated by adjusting the time durations of the first and third phase, whereas an increase of these time durations (dependent on the second control signal S_{CTRL2}) results in an increase of the output current 12.

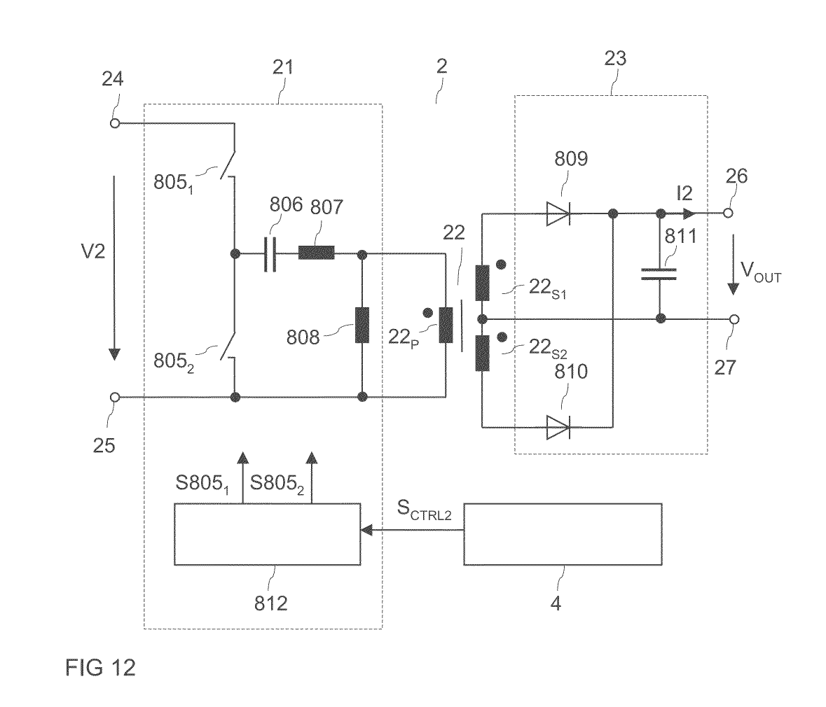

FIG. 12 illustrates a power converter circuit according to a further embodiment. The power converter circuit of FIG. 12 includes an LLC resonant topology. Referring to FIG. 12, the switching circuit 21 of the DC/DC converter 2 includes a half-bridge with a high-side switch 805₁ and a low-side switch 805₂ connected between the input terminals 24, 25 for receiving the DC link voltage V2. The switching circuit further includes a series LLC circuit with a capacitive storage element 806, an inductive storage element 807, and the primary winding 22_{P} of the transformer 22. This series LLC circuit is connected in parallel with the low-side switch 805₂. A further inductive storage element 808 is connected in parallel with the primary winding 22_{P}.

The transformer 22 includes a center tap resulting in two secondary winding sections, namely a first secondary winding section 22_{S1} and a second secondary winding section 22_{S2} coupled to the primary winding 22_{P} and each having the same winding sense as the primary winding 22_{P}. In the rectifier circuit 23, the first secondary winding section 22_{S1} is coupled to the first output terminal 26 through a first rectifier element 809, and the second secondary winding section 22_{S2} is coupled to the first output terminal 26 through a second rectifier element 810. A circuit node common to the first and second secondary winding sections 22_{S1}, 22_{S2} is coupled to the second output terminal 27. A capacitive storage element 811 is connected between the output terminals 26, 27. The output voltage V_{OUT} is available between the output terminals 26, 27.

In FIG. 12, S805₁, S805₂ denotes drive signals for the switches 805₁, 805₂ of the half-bridge. These drive signals S805₁, S805₂ are generated by a drive circuit 812 in accordance with the second control signal S_{CTRL2}.

In the power converter circuit of FIG. 12, the high-side switch 805₁ and the low-side switch 805₂ are switched on and off alternatingly. This causes an alternating current through the primary winding 22_{P} of the transformer 22. This alternating current is transferred to the secondary side. When the alternating current through the primary winding 22_{P} has a first direction, a current on the secondary side flows through the first secondary winding section 22_{S1} and the first rectifier element 809 to the capacitive storage element 811 and the output terminals 26, 27 respectively. When the current through the primary winding 809₁, has an opposite second direction, the current on the secondary side flows through the second secondary winding section 22_{S2} and the second rectifier element 810 to the capacitive storage element 811 and the output terminals 26, 27, respectively. The series LLC circuit has two resonance frequencies, namely a first resonance frequency, and a second resonance frequency lower than the first resonance frequency. In order to control the input power of the DC/DC converter 2, the control circuit 812 operates the first and second switches 805₁, 805₂ with a frequency that is typically between the first and the second resonance frequency and close to the first resonance frequency, wherein through a variation of the switching frequency the quality factor of the LLC circuit can be varied. By varying the quality factor the input power and, therefore, the output current 12 of the DC/DC converter 2 can be adjusted.

Although a flyback topology, a TTF topology, a phase-shift ZVS topology, and a half-bridge LLC topology have been explained in detail, the implementation of the DC/DC converters 2 is not restricted to these topologies. Other conventional DC/DC converter topologies, such as a single transistor forward topology, a full-bridge LLC topology, or an active clamp forward topology may be used as well. These topologies are commonly known, so that no further explanations are required in this regard. Further, the individual DC/DC converters 2 could be implemented as interleaved DC/DC converters. An interleaved DC/DC converter includes at least two of the topologies explained herein below, wherein these topologies are connected in parallel so as to commonly receive the DC link voltage V2 and so as to commonly generate the output current 12, and wherein the individual topologies connected in parallel are activated in a timely interleaved fashion.

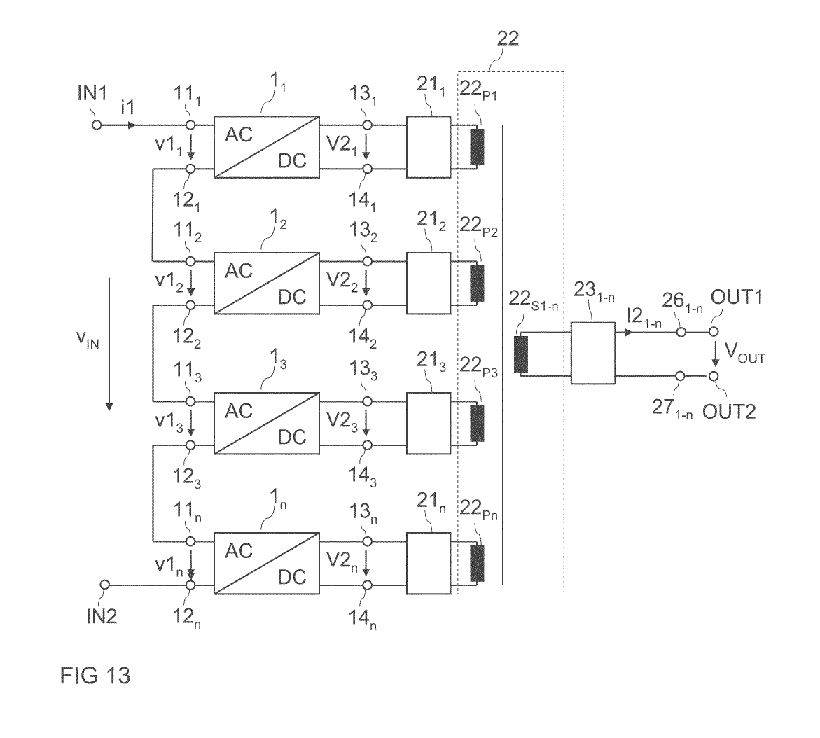

FIG. 13 illustrates a further embodiment of an AC/DC power converter arrangement. The power converter arrangement of FIG. 13 is different from the power converter arrangement of FIG. 1 in that the individual DC/DC converters share one rectifier circuit 23₁₋ₙ. That is, each of the AC/DC converters 1₁-4 has one switching circuit 21₁-21ₙ connected to its output terminals 13₁-13ₙ, 14₁-14ₙ, where a primary winding 22_{P1}-22_{Pn} is connected to each of the switching circuits 21₁-21ₙ. The primary windings 22_{P1}-22_{Pn} are inductively coupled with each other. Further, the primary windings 22_{P1}-22_{Pn} are inductively coupled with a common secondary winding 22_{S1-n}. The common rectifier circuit 23₁₋ₙ is connected to the common secondary winding 22_{S1-n} and provides an output current I2₁₋ₙ at output terminals 26₁₋ₙ, 27₁₋ₙ, where these output terminals 26₁₋ₙ, 27₁₋ₙ are connected to the output terminals OUT1, OUT2, respectively, of the power converter arrangement.

In the power converter arrangement of FIG. 13, each of the switching circuits 21₁-21ₙ forms a DC/DC converter with the common rectifier circuit 23₁₋ₙ. The DC/DC converters can be implemented with one of the topologies explained herein before. The topology of the common rectifier circuit 23₁₋ₙ is adapted to the topology of the switching circuits 21₁-21ₙ. That is, the common rectifier circuit 23₁₋ₙ has a topology corresponding to the topology of the rectifier circuit 23 in FIGS. 2A or 2B when the DC/DC converters are flyback converters and have switching circuits with a topology corresponding to the topology of the switching circuit 21 of FIG. 2A. The common rectifier circuit has a topology corresponding to the rectifier circuit 23 of FIG. 10 when the DC/DC converters have a TTF topology so that the individual switching circuits 21 have a topology corresponding to the topology of the switching circuit 21 of FIG. 10. The common rectifier circuit 23₁₋ₙ has a topology corresponding to the rectifier circuit 23 of FIG. 11, when the DC/DC converters are implemented with a phase-shift ZVS topology, so that the individual switching circuit 21₁-21ₙ have topology corresponding to the switching circuit 21 of FIG. 11. And the common rectifier circuit 23₁₋ₙ has a topology corresponding to the rectifier circuit 23 of FIG. 12, when the DC/DC converters are implemented with an LLC topology, so that the individual switching circuits 21₁-21ₙ have a topology corresponding to the switching circuit 21 of FIG. 12.

The operating principle of the AC/DC converter arrangement in FIG. 13 corresponds to the operating principle of the AC/DC arrangement of FIG. 1. That is, one of the AC/DC converters 1₁-1ₙ is a master AC/DC converter that controls the input current i1 and its DC link voltage V2, while the other AC/DC converters 1₁-1ₙ are slave AC/DC converters that control their input voltages v1 to be a predefined share of the overall input voltage v_{IN}. The switching circuit 21 connected to the master AC/DC converter forms a master DC/DC converter together with the common rectifier circuit 23₁₋ₙ. This master DC/DC converter controls the output voltage V_{OUT}. In this case, the controller 4 (see FIG. 4) of the mater AC/DC converter receives a current signal representing the overall output current 12₁₋ₙ instead of a current signal S₁₂ (see FIG. 4) that only represents the output current of the master AC/DC converter. The other switching circuits form slave DC/DC converters together with the common rectifier circuit 23₁₋ₙ and control the DC link voltages. For explanation purposes it is assumed that the individual DC/DC converters are implemented as flyback converters as illustrated with reference to FIGS. 2A and 2B. Since the individual primary windings 22_{P1}-22_{Pn} are inductively coupled it is possible that energy from one switching circuit 21, is transferred into another switching circuit 21ⱼ (with i≠j). Such an energy transfer from a converter with a higher DC link voltage to other converters with lower DC link voltages will continue until the DC link voltages of the individual DC/DC converters are equalized.

According to a further embodiment, the individual switching circuits 21₁-21ₙ are operated in an interleaved fashion such that the switches in the individual switching circuits 21₁-21ₙ that connect the corresponding primary windings 22_{P1}-22_{Pn} to the corresponding DC link voltage V2₁-V2ₙ are activated subsequently, such that on-periods of the individual switches do not overlap. That is, that the switch of only one rectifier circuit is switched on at the same time.

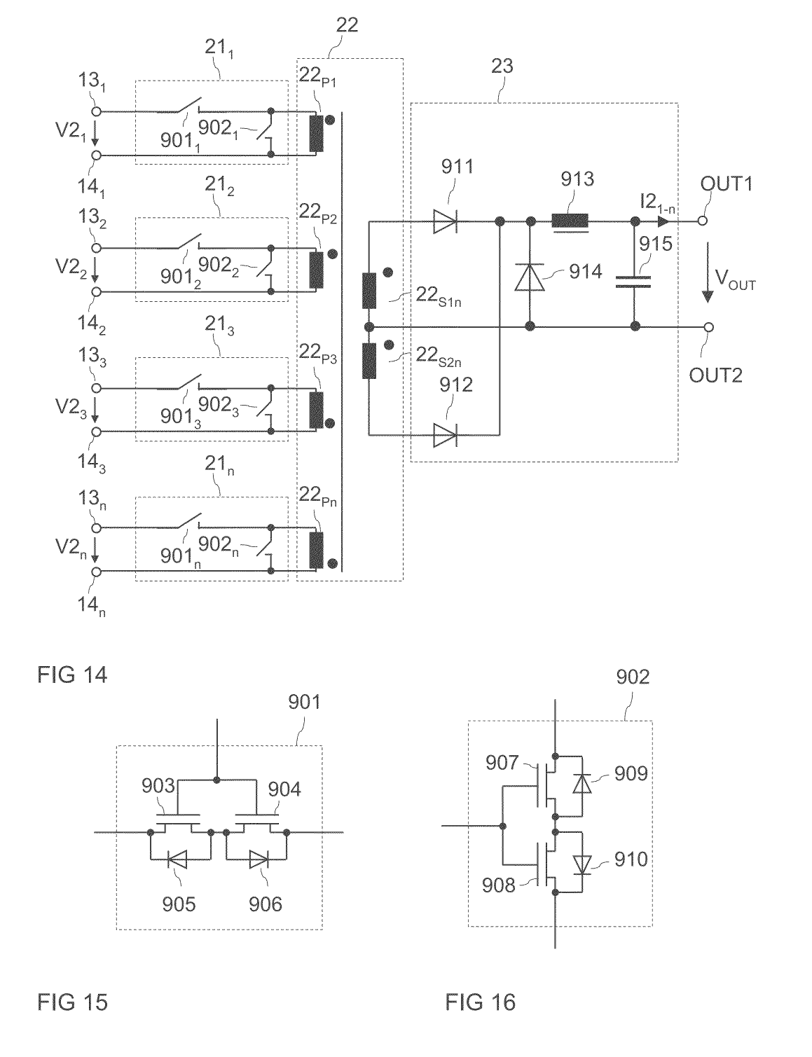

FIG. 14 illustrates one embodiment of the switching circuits 21₁-21ₙ of the AC/DC converter arrangement of FIG. 13, and one embodiment of the rectifier circuit 23. FIG. 14 only shows the DC/DC stage of the AC/DC converter arrangement, the AC/DC stage is not illustrated in FIG. 14 and can be implemented in accordance with one of the embodiments explained before.

Referring to FIG. 14, each switching circuit 21 (reference character 21 denotes an arbitrary one of the switching circuits 21₁-21ₙ) includes a first switch 901 connected in series with the primary winding 22_{P} of the corresponding switching circuit 21. The series circuit with the first switch 901 and the primary winding 22_{P} is connected between the input terminals 13, 14 of the corresponding switching circuit 21. Further, each switching circuit 21 includes a second switch 902 connected in parallel with the corresponding primary winding 22_{P}.

In the embodiment of FIG. 14, the DC/DC stage includes four switching circuits 21₁-21ₙ. In the present embodiment, there is a first group of switching circuits having a primary winding with a first winding sense, and a second group of switching circuits having a primary winding with a second winding sense opposite the first winding sense. In the present embodiment, switching circuits 21₁, 21₂ belong to the first group, while switching circuits 21₃, 21ₙ belong to the second group.

The rectifier circuit corresponds to the rectifier circuit 23 of FIG. 11 and includes a secondary winding with a first secondary winding section 22_{S1n} and a second secondary winding section 22_{S2n}. The secondary winding with the first and second secondary winding sections 22_{S1n}, 22_{S2n} is inductively coupled with the primary windings 22_{P1}-22_{Pn} of the transformer 22. A circuit node common to the first and second secondary winding sections 22_{S1n}, 22_{S2n} is coupled to a second output terminal OUT2. A further rectifier element 914, such as a diode, has a first terminal (anode) coupled to the second output terminal OUT2. The further rectifier element 914 further includes a second terminal (cathode). A terminal of the first secondary winding 22_{S1n} that faces away from the common circuit node is coupled to the second terminal of the capacitive storage element 914 through a first rectifier element such as a diode, and a circuit node of the second secondary winding section 22_{S2n} that faces away from the common circuit node is coupled to the second terminal of the capacitive storage element 914 through a second rectifier element 912 such as a diode. A rectifier circuit of FIG. 14 is different from the rectifier circuit of FIG. 12 in that the rectifier circuit of FIG. 14 additionally includes a series circuit with an inductive storage element 913 and a further capacitive storage element 915, wherein this series circuit is connected in parallel with the capacitive storage element 914. The output voltage v_{OUT} is available across the further capacitive storage element 915.

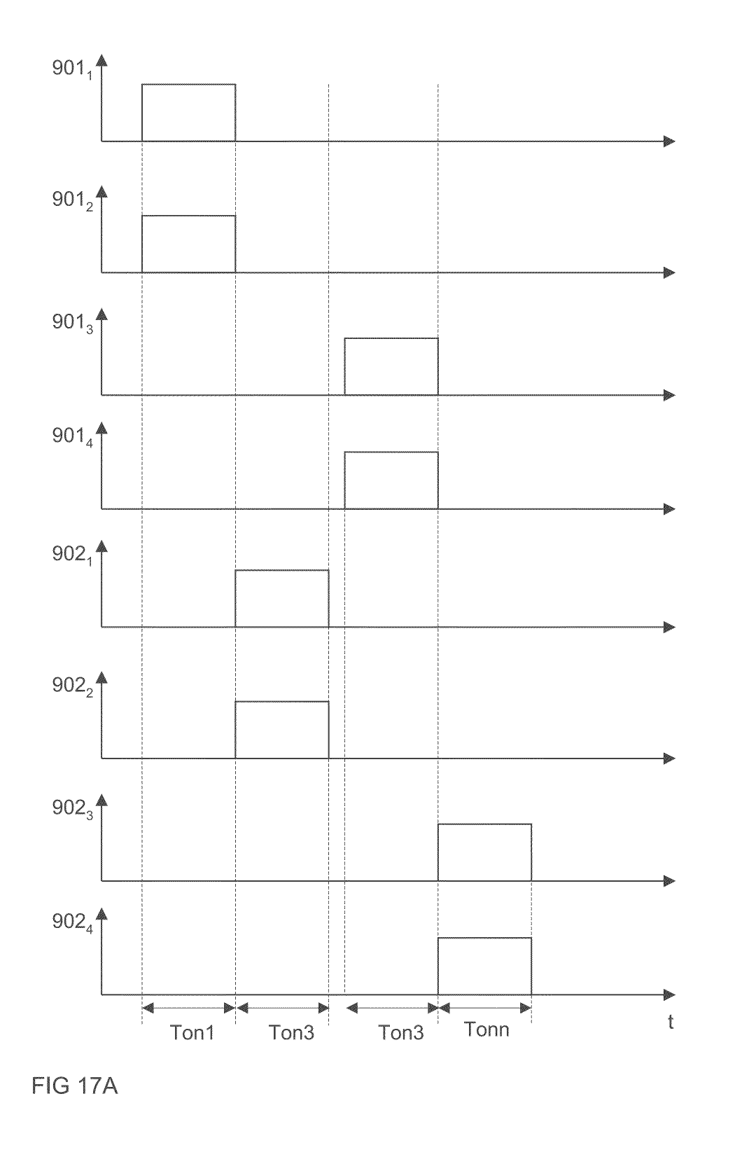

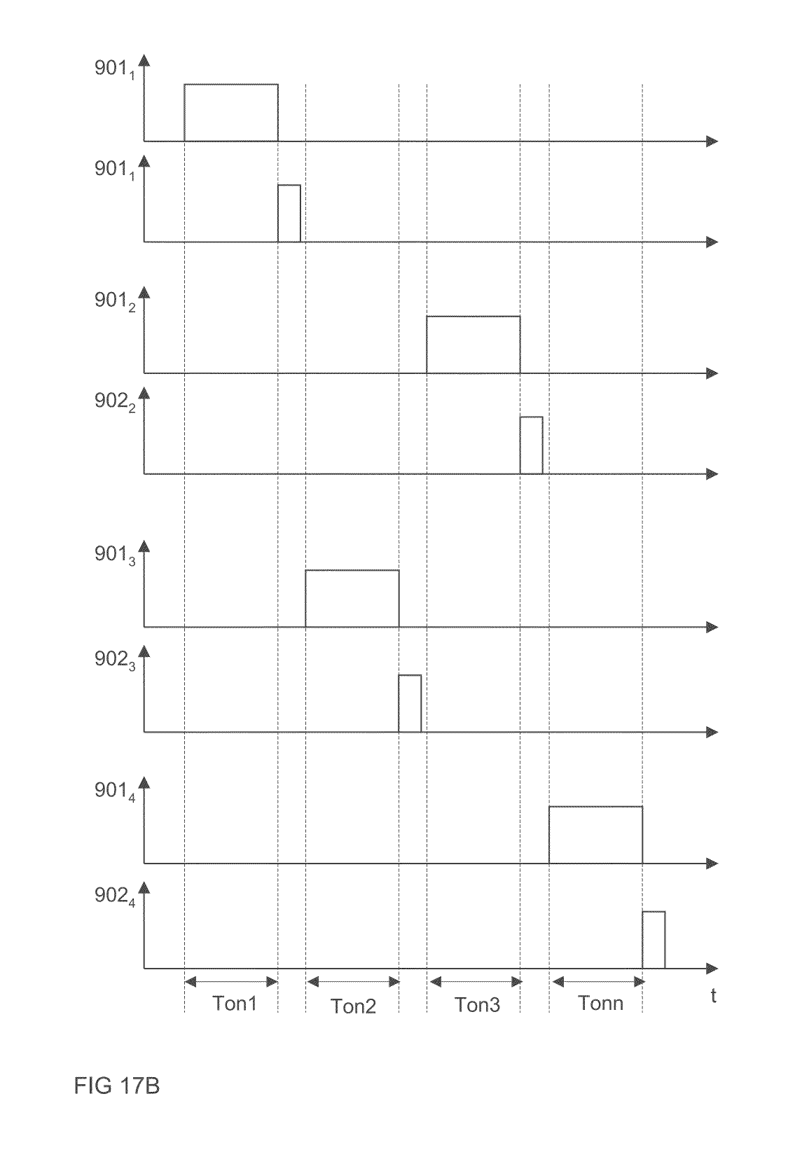

Each of the first and second switches 901, 902 in the individual switching circuits 21 is capable of blocking voltages of both polarities. That is, each of these switches is capable of blocking a voltage having a first polarity applied thereto, and is capable of blocking voltage with a second polarity opposite to the first polarity applied thereto. Like in the switching circuits explained herein before, each of the switching circuits 21₁-21ₙ includes a control circuit (not illustrated in FIG. 14) that controls the operation of the first and second switch in each of the switching circuits 21₁-21ₙ. The operating principle of this control circuit will be explained with reference to FIG. 17 herein below.

The individual first and second switches 901, 902 can be implemented in a conventional way. Just for illustration purposes, one embodiment for implementing the first switches 901 in the individual switching circuits 21 is illustrated in FIG. 15, and one embodiment for implementing the second switches 902 is illustrated in FIG. 16. Referring to FIG. 15, each first switch 901 may include two MOSFETs 903, 904 that have their load paths (drain-source paths) connected in series such that integrated body diodes 905, 906 of the two MOSFETs 903, 904 are connected back-to-back. That is, either the anodes of the diodes 905, 906 are connected (as illustrated), or the cathodes of the diodes are connected (not illustrated). The two MOSFETs 903, 904 may have their control terminals (gate terminals) connected so that the two MOSFETs 903, 904 can be controlled by one control signal. Alternatively true bidirectional blocking switches may be used. Such switches are, e.g., lateral gallium-nitride-(GaN)-based High Electron Mobility Transistors (HEMTs).

The second switches 902 can be implemented in the same way as the first switches 901. Referring to FIG. 16, each second switch 902 may include a series circuit with two MOSFETs 907, 908 that have their load paths (drain-source paths) connected in series such that integrated body diodes 909, 910 of the two MOSFETs are connected back-to-back. The control terminals (gate terminals) of the two MOSFETs can be connected.

Two embodiments of a method for operating the circuit of FIG. 14 are explained below with reference to FIGS. 17A and 17B. FIGS. 17A and 17B each show timing diagrams of switching states (operation states) of the first and second switches 901, 902 in the circuit of FIG. 14. In the timing diagrams of FIGS. 17A and 17B, a high level of the switching state represents an on-state of the corresponding switch, and a low level represents an off-state of the corresponding switch.

In the embodiment illustrated in FIG. 17A, the first switches 901 of those switching circuits 21 that have primary windings 22_{P} with the same winding sense are switched on at the same time. Thus, in the present embodiment, the first switches 901₁, 901₂ of the first and second switching circuits 21₁, 21₂ of the first group coupled to primary windings 22_{P1}, 22_{P2} with the first winding sense are switched on during a first on-period Ton1, and the first switches 901₃, 903ₙ of the first and second switching circuits 21₃, 21ₙ of the second group coupled to primary windings 22_{P3}, 22_{Pn} with the second winding sense are switched on during a second on-period Ton2. The first and second on-periods Ton1, Ton2 do not overlap, so that the first switches 901₁, 901₂ of the switching circuits 21₁, 21₂ of the first group and the first switches 901₃, 901ₙ of the switching circuits 21₃, 21ₙ of the second group are not switched on at the same time.

When the first switches 901₁, 901₂ of the first group are switched on, a voltage across the first winding section 22_{S1n} of the secondary winding has a polarity that causes the first diode 911 to conduct, so that during the first on-period Ton1 energy is transferred from the primary side to the secondary side and to the output terminals OUT1, OUT2. Further, when the DC link voltages V2₁, V2₂ of the first and second switching circuits 21₁, 21₂ are different, energy is transferred via the transformer 22 and the first switches 901₁, 901₂ from the DC link capacitor (not shown) of that switching circuit 21 which has the higher DC link voltage to the DC link capacitor of that switching circuit which has the lower DC link voltage. Referring to FIG. 17A, after the first switches 901₁, 901₂ of the first group have been switched off, the second switches 902₁, 902₂ of the first group are switched on for a third time period Ton3. Through this, a freewheeling path is provided that clamps a voltage that can be induced in a stray inductance (not shown) of the transformer 22. Optionally, a resistor (not shown) is connected in series with each of the second switches 902₁, 902₂. This resistor dampens oscillations that may occur in the freewheeling path.

The third on-period Ton3 and the second on-period Ton2 do not overlap. That is, the first switches 901₃, 901ₙ of the second group are switched on after the second switches 902₁, 902₂ of the first group have been switched off. When the first switches 901₃, 901₃ of the second group are switched on, a voltage across the second winding section 22_{S2n} of the secondary winding has a polarity that causes the second diode 912 to conduct, so that during the second on-period Ton2 energy is transferred from the primary side to the secondary side and to the output terminals OUT1, OUT2. Further, when the DC link voltages V2₃, V2ₙ of the third and fourth switching circuits 21₃, 21ₙ are different, energy is transferred via the transformer 22 and the first switches 901₁, 901₂ from the DC link capacitor (not shown) of that switching circuit 21 which has the higher DC link voltage to the DC link capacitor of that switching circuit which has the lower DC link voltage. Referring to FIG. 17A, after the first switches 901₃, 901ₙ of the second group have been switched off, the second switches 902₃, 902ₙ of the first group are switched on for a fourth time period Tonn. Through this, a freewheeling path is provided that clamps a voltage that can be induced in a stray inductance (not shown) of the transformer 22. Optionally, a resistor (not shown) is connected in series with each of the second switches 902₃, 902ₙ. This resistor dampens oscillations that may occur in the freewheeling path.

Referring to FIG. 17A, one drive cycle of the DC/DC converters of FIG. 14 includes the first, second, third, and fourth on-periods that do not overlap. After the second switches 902₃, 902ₙ of the second group have been switched off, a new drive cycle may start at the beginning of which the first switches 901₁, 901₂ of the first group are switched on.

According to a further embodiment which is illustrated in FIG. 17B, the first switches 901 of the switching circuits 21 are switched subsequently such that the individual on-periods do not overlap. In the present embodiment, in a one drive cycle the first switches 901 are switched on in the following sequence:

first 901₁ switch of the first switching circuit 21₁ for a first on-period Ton1,

first 901₃ switch of the third switching circuit 21₃ for a second on-period Ton2,

first 901₂ switch of the second switching circuit 21₂ for a third on-period Ton3,

first 901₁ switch of the fourth switching circuit 21ₙ for a fourths on-period Tonn.

Thus, in this embodiment, switching circuits 21₁, 21₂ coupled to primary windings 22_{P1}, 22_{P2} with the first winding sense, and switching circuits 21₃, 21ₙ coupled to primary windings with the second winding sense 22_{P3}, 22_{Pn} are activated alternately in order to alternately magnetize the transformer 22 in a first direction by applying a voltage with a first polarity to one of the primary windings, and in a second direction by applying a voltage with a second polarity to one of the primary windings.

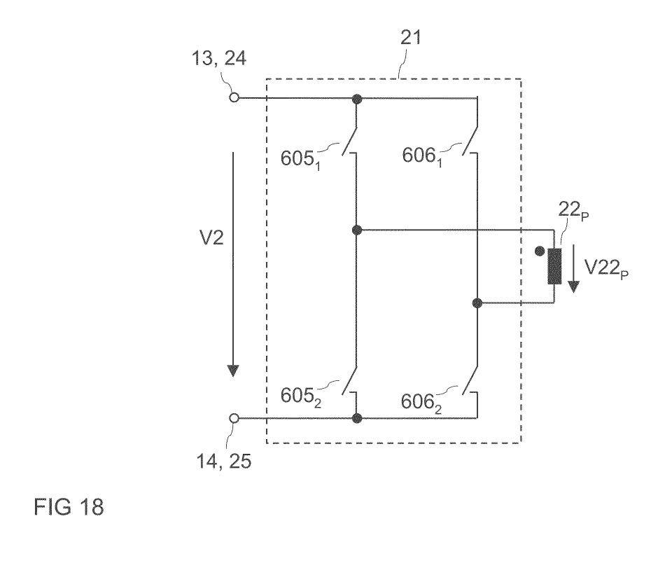

FIG. 18 illustrates a further embodiment for implementing the switching circuits 21 in the circuit of FIG. 14 in which the individual DC/DC converters share one rectifying circuit. FIG. 18 shows one switching circuit 21 receiving a DC link voltage V2 at input terminals 24, 25 (that correspond to output terminals 13, 14) of an AC/DC converter (not shown). Each of the switching circuits 21₁-21ₙ can be replaced by a switching circuit 21 as illustrated in FIG. 18.

The switching circuit 21 of FIG. 18 is based on the switching circuit of FIG. 11 and includes a full-bridge with two half-bridges which are each connected between the input terminals and which have the primary winding connected between their output terminals. The inductive storage element shown in FIG. 11 is omitted in the switching circuit of FIG. 18.

The switching circuit 21 with the full-bridge of FIG. 18 is capable of magnetizing the transformer (from which only one primary winding 22_{P} is illustrated in FIG. 18) in the first direction or the second direction by suitably driving the individual switches. Thus, using a switching circuit 21 of the type illustrated in FIG. 18 a circuit with a plurality of switching circuits 21 can be implemented in which a first group of switching circuits magnetizes the transformer in a first direction, and in which a second group of switching circuits magnetizes the transformer in a second direction.

Referring to FIG. 18, a switching circuit of the first group magnetizes the transformer in the first direction by switching on the first switch 605₁ of the first half-bridge and the second switch 606₂ of the second half-bridge. In this case, the polarity of a voltage V22_{P} across the primary winding is as illustrated in FIG. 18. After these switches have been switched off, a freewheeling path for a current induced in stray inductances (not illustrated) is provided by the switches 605₂ and 606₁. This freewheeling path allows to feed the energy of the stray inductance back to the DC link capacitor of inverter 21. According to one embodiment, the individual switches 605₁, 605₂, 606₁, 606₂ are implemented as MOSFETs (e.g., as n-type MOSFETs) with an integrated body diode. The freewheeling path is either provided by switching on the switches 605₂ and 606₁ or is only provided by the body diodes of the switches 605₂, 606₁ so that these switches 605₂, 606₁ not necessarily have to be switched on.

A switching circuit of the second group magnetizes the transformer in the second direction by switching on the first switch 606₁ of the second half-bridge and the second switch 605₂ of the first half-bridge. In this case, the polarity of a voltage V22_{P} across the primary winding is opposite to the polarity illustrated in FIG. 18. After these switches have been switched off, a freewheeling path for a current induced in stray inductances (not illustrated) is provided by the switches 605₁ and 606₂. According to one embodiment, the individual switches 605₁, 605₂, 606₁, 606₂ are implemented as MOSFETs (e.g., as n-type MOSFETs) with an integrated body diode. The freewheeling path is either provided by switching on the switches 605₁ and 606₂ or is only provided by the body diodes of the switches 605₁, 606₂ so that these switches 605₁, 606₂ not necessarily have to be switched on.

Like in the method explained with reference to FIG. 17A, the switching circuits of the first group may be activated at the same time, that is during a first on-period, and the switching circuits of the second group may be activated at the same time, that is during a second on-period, where these on-periods do not overlap. Alternatively, like in the method explained with reference to FIG. 17B, the individual switching circuits are activated alternately.

More complex topologies such as a phase shift ZVS full bridge may be utilized in the same manner as described above. With respect to the operation of the full bridge we refer to the detailed explanation given in the context with FIG. 11.

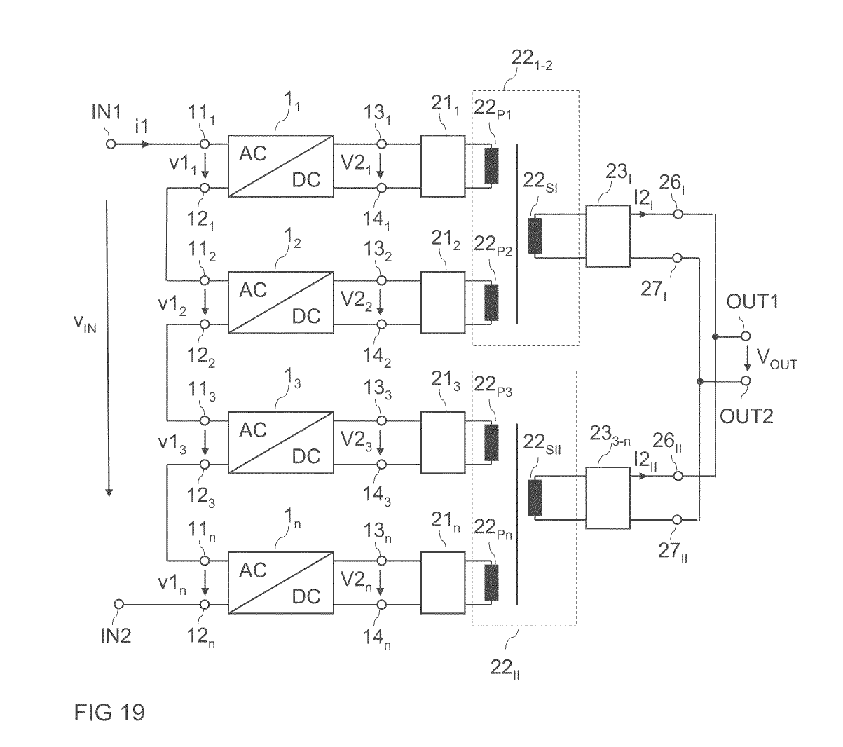

FIG. 19 illustrates a further embodiment of an AC/DC power converter arrangement. The power converter arrangement of FIG. 19 is a combination of the topologies explained with reference to FIGS. 1 and 11. In the power converter arrangement of FIG. 19, a first group of DC/DC converters share one rectifier circuit 23₁₋₂, and a second group of DC/DC converters share one rectifier circuit 23₃₋ₙ. Output terminals 26₁₋₂, 27₁₋₂ and 26₃₋ₙ, 27₃₋ₙ are connected to the output terminals OUT1, OUT2, so that the rectifier circuits 23₁₋₂, 23₃₋ₙ have their outputs connected in parallel. In the present embodiment, each group of DC/DC converters that share one rectifier circuit 23₁₋₂, 23₃₋ₙ includes two DC/DC converters, namely in case of the first group the DC/DC converters with the switching circuits 21₁-21₂ connected to the AC/DC converters 1₁, 1₂, respectively, and in case of the second group the DC/DC converters with the switching circuits 21₃, 21ₙ connected to the AC/DC converters 1₃, 1ₙ. However, this is only an example. Generally, the number of DC/DC converters in one group that share a rectifier circuit is arbitrary. Further, the power converter arrangement may be implemented with more than two groups of DC/DC converters, with the DC/DC converters of one group sharing one rectifier circuit.

The primary windings of the transformers of the DC/DC converters of one group are inductively coupled with each other and are inductively coupled with one secondary winding. That is, in the present embodiment, the primary windings 22_{P1}, 22_{P2} of the first group are inductively coupled with each other and are inductively coupled with the secondary winding 22_{S1-2} connected to the rectifier circuit 23₁₋₂, and the primary windings 22_{P3}, 22_{Pn} of the second group are inductively coupled with each other and are inductively coupled with the secondary winding 22_{S3-n} that is connected to the rectifier circuit 23₃₋ₙ.

The operating principle of the power converter arrangement of FIG. 19 corresponds to the operating principle of the power converter arrangements explained with reference to FIGS. 1 and 11. That is, one of the AC/DC converters 1₁-1ₙ is a master AC/DC converter that controls the input current i1, while the other AC/DC converters are slave AC/DC converters that only control their input voltages v1. Further, the DC/DC converter connected to the master AC/DC converter acts as a master DC/DC converter that controls the output voltage V_{OUT}, while the other DC/DC converters act as slave AC/DC converters that only control the DC link voltages V2. Within one group, the individual DC/DC converters are either synchronized such that the primary windings are connected to the DC link voltages at the same times, or such that the primary windings are connected to the DC link voltages (in order to magnetize the primary windings) in an interleaved fashion.

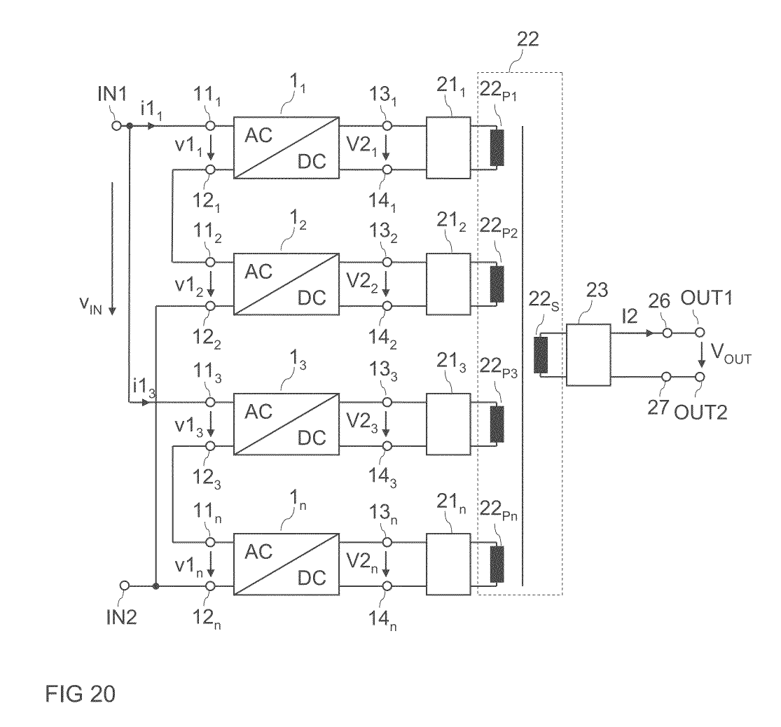

FIG. 20 illustrates a further embodiment of an AC/DC power converter arrangement. In the power converter arrangement of FIG. 20, there are two groups of AC/DC converters, wherein the AC/DC converters of each group are connected in series between the input terminals IN1, IN2. In the present embodiment, a first group with AC/DC converters 1₁, 1₂ is connected between the input terminals IN1, IN2, and a second group with AC/DC converters 1₃, 1ₙ is connected between the input terminals IN1, N2. Each AC/DC converter 1₁-1ₙ has a DC/DC converter connected to its output terminals 13₁-13ₙ, 14₁-14ₙ, where the individual DC/DC converters share one rectifier circuit 23₁₋ₙ. The primary windings 22_{P1}-22_{Pn} of the individual DC/DC converters are inductively coupled with each other and are inductively coupled with one secondary winding 22_{S1-n} that is connected to the common rectifier circuit 23₁₋ₙ.

The operating principle of the power converter arrangement of FIG. 20 is similar to the operating principle of the power converter arrangement of FIG. 13, with the difference that in each group one AC/DC converter is a master AC/DC converter that controls the input current of the respective group (these input currents are labeled with i1₁, i1₃ in FIG. 20). Further, the individual AC/DC converters control the individual DC link voltages V2 such that the individual DC link voltages are essentially identical. One DC/DC converter connected to one of the master AC/DC converters is a master DC/DC converter that controls the output voltage V_{OUT}, while the other DC/DC converters are slave converters.

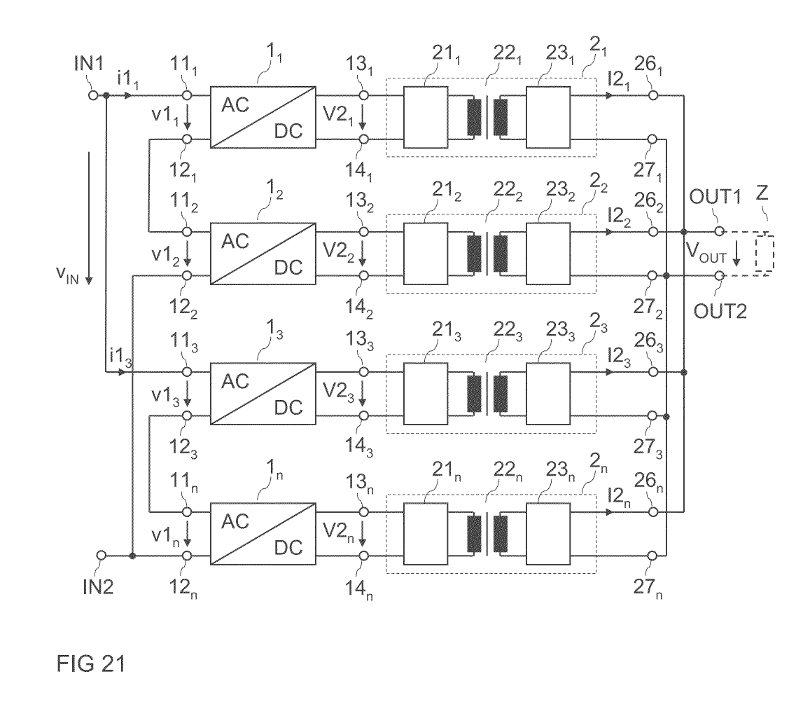

FIG. 21 illustrates a modification of the AC/DC converter arrangement of FIG. 20. In the AC/DC converter of FIG. 21, each DC/DC converter 22 includes a switching arrangement 21, a transformer 22 and a rectifier circuit 23. The output terminals 26, 27 of the individual DC/DC converters 22 are connected in parallel and are connected to the output terminals OUT1, OUT2. The control of the circuit arrangement of FIG. 21 corresponds to the control of the circuit of FIG. 20, that is there is one master AC/DC converter in each group, and the individual AC/DC converter each control the DC link voltage.

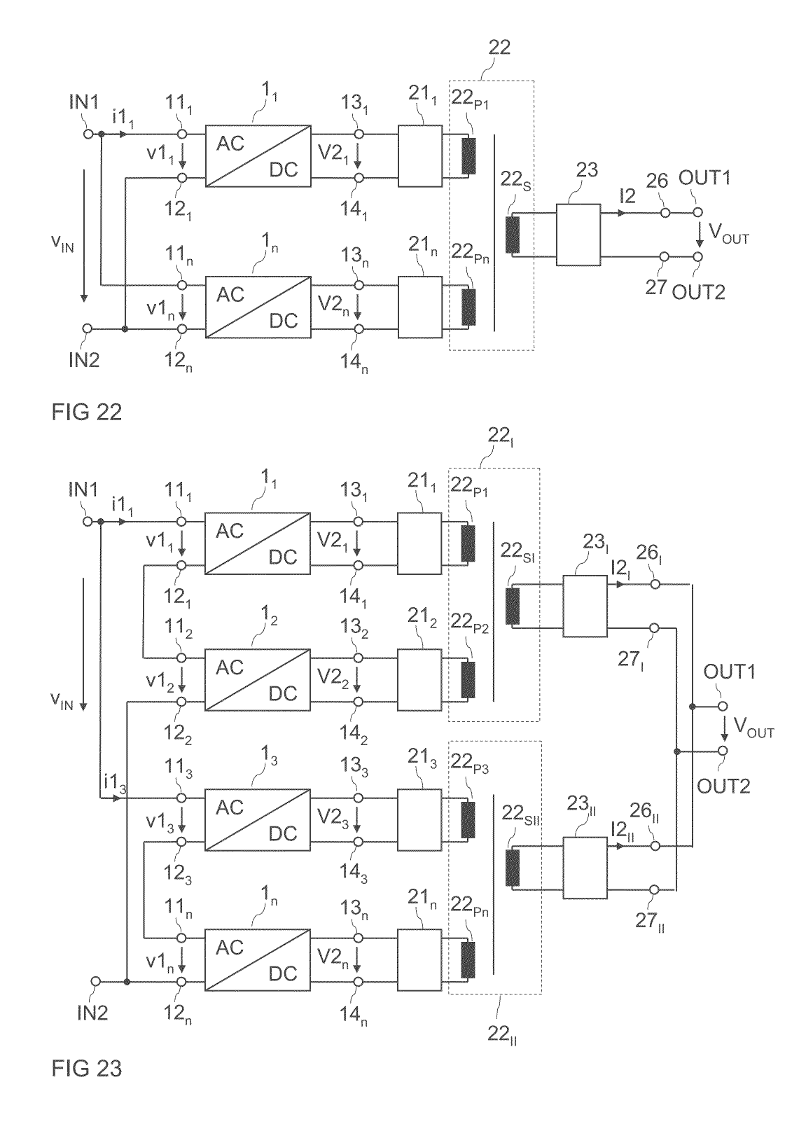

FIG. 22 illustrates a further modification of the AC/DC converter arrangement of FIG. 20. In the AC/DC converter arrangement of FIG. 21, each of the two groups of AC/DC converters only includes one AC/DC converter, namely AC/DC converter 1₁ in case of the first group, and AC/DC converter 1ₙ in case of the second group.

FIG. 23 illustrates yet another modification of the AC/DC converter arrangement of FIG. 20. The AC/DC converter arrangement of FIG. 22 is different from the AC/DC converter arrangement of FIG. 20 in that the DC/DC converter connected to the AC/DC converters of one group include one transformer and one rectifier circuit. That is, the switching arrangements 21₁, 21₂ that are connected to the AC/DC converters 1₁, 1₂ of the first group are coupled to a first rectifier circuit 23_{I} through a first transformer 22_{I}, wherein the transformer 22_{I} has a primary winding 22_{P1}, 22_{P2} connected to each of the switching arrangements 21₁, 21₂, and has one secondary winding 22_{SI} inductively coupled to the primary winding 22_{P1}, 22_{P2} and connected to the first rectifier circuit 23_{I}. Equivalently, switching arrangement 21₃, 21ₙ that are connected to the AC/DC converters 1₃, 1ₙ of the second group are coupled to a second rectifier circuit 23_{II} through a second transformer 22_{II}, wherein the second transformer 22_{II} has a primary winding 22_{P3}, 22_{Pn} connected to each switching arrangement 21_{III}, 21ₙ, and one secondary winding 22_{SII} connected to the second rectifier circuit 23_{II}. Output terminals 26_{I}, 26_{II}, 27_{I}, 27_{II} of the two rectifier circuits 23_{I}, 23_{II} are connected to the output terminals OUT1, OUT2 while the output voltage V_{OUT} is available.

Although various exemplary embodiments of the invention have been disclosed, it will be apparent to those skilled in the art that various changes and modifications can be made which will achieve some of the advantages of the invention without departing from the spirit and scope of the invention. It will be obvious to those reasonably skilled in the art that other components performing the same functions may be suitably substituted. It should be mentioned that features explained with reference to a specific figure may be combined with features of other figures, even in those cases in which this has not explicitly been mentioned. Further, the methods of the invention may be achieved in either all software implementations, using the appropriate processor instructions, or in hybrid implementations that utilize a combination of hardware logic and software logic to achieve the same results. Such modifications to the inventive concept are intended to be covered by the appended claims.

Spatially relative terms such as “under,” “below,” “lower,” “over,” “upper” and the like, are used for ease of description to explain the positioning of one element relative to a second element. These terms are intended to encompass different orientations of the device in addition to different orientations than those depicted in the figures. Further, terms such as “first,” “second” and the like, are also used to describe various elements, regions, sections, etc. and are also not intended to be limiting. Like terms refer to like elements throughout the description.

As used herein, the terms “having,” “containing,” “including,” “comprising” and the like are open ended terms that indicate the presence of stated elements or features, but do not preclude additional elements or features. The articles “a,” “an” and “the” are intended to include the plural as well as the singular, unless the context clearly indicates otherwise.

It is to be understood that the features of the various embodiments described herein may be combined with each other, unless specifically noted otherwise.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A converter arrangement, comprising:
a DC/DC stage comprising a plurality of DC/DC converters, wherein each of the plurality of DC/DC converters is operable to receive one of a plurality of direct input voltages, and wherein the DC/DC stage is configured to generate an output voltage from the plurality of direct input voltages.

2. The converter arrangement of claim 1, wherein the plurality of DC/DC converters of the DC/DC stage generate, in combination, the output voltage of the DC/DC stage.

3. The converter arrangement of claim 1, wherein the plurality of DC/DC converters each receive one of the plurality of direct input voltages that are based on a portion of an input voltage of the converter arrangement.

4. The converter arrangement of claim 1, wherein the plurality of direct input voltages comprise one or more of a plurality of substantially direct current (DC) input voltages and a plurality of substantially direct voltage input voltages.

5. The converter arrangement of claim 1, further comprising an AC/DC stage configured to receive an alternating input voltage and to output the plurality of direct input voltages based on the received alternating input voltage.

6. The converter arrangement of claim 5, wherein the AC/DC stage comprises:
an AC/DC converter configured to receive the alternating input voltage and to output a substantially direct intermediate voltage; and
a series circuit comprising a plurality of capacitive storage elements and configured to receive the direct intermediate voltage, wherein each of the plurality of capacitive storage elements is configured to output one of the plurality of direct input voltages.

7. The converter arrangement of claim 6, wherein the AC/DC converter is further configured to receive an input current and is operable to control a phase difference between the input current and the alternating input voltage.

8. The converter arrangement of claim 7, wherein the AC/DC converter is configured to control the phase difference to be substantially constant.

9. The converter arrangement of claim 5, wherein the AC/DC stage further comprises:
a rectifier configured to receive the alternating input voltage and to output a rectified input voltage; and
a series circuit comprising a plurality of voltage converters connected in series, wherein the series circuit is configured to receive the rectified input voltage, and wherein each voltage converter is configured to output one of the plurality of direct input voltages.

10. The converter arrangement of claim 9, wherein the plurality of voltage converters comprises AC/DC converters.

11. The converter arrangement of claim 5, wherein the AC/DC stage further comprises a series circuit comprising a plurality of AC/DC converters connected in series, wherein the series circuit is configured to receive the alternating input voltage, and wherein each of the plurality of AC/DC converters is configured to output one of the plurality of direct input voltages.

12. The converter arrangement of claim 11,
wherein one of the plurality of AC/DC converters is configured to operate as a master AC/DC converter operable to receive an input current and control a phase difference between the input current and the alternating input voltage; and
wherein the other AC/DC converters of the plurality of AC/DC converters are each configured to operate as a slave AC/DC converter operable to receive one of the plurality of direct input voltages and control a voltage level of the respective received direct input voltage.

13. The converter arrangement of claim 12, wherein the master AC/DC converter is operable to control the phase difference to be substantially constant.

14. The converter arrangement of claim 1, wherein each DC/DC converter of the plurality of DC/DC converters comprises:
a switching circuit operable to receive the one of the plurality of direct input voltages;
a transformer comprising a primary winding coupled to the switching circuit and a secondary winding; and
a rectifier circuit coupled to the secondary winding and comprising an output coupled to an output of the converter arrangement.

15. The converter arrangement of claim 14, wherein one of the plurality of DC/DC converters is configured to operate as a master DC/DC converter operable to control a voltage level at the output of the converter arrangement.

16. The converter arrangement of claim 1, wherein each of the plurality of DC/DC converters is implemented with at least one topology selected from the group consisting of:
a phase-shift ZVS converter topology;
a TTF converter topology; and
an LLC converter topology.

17. The converter arrangement of claim 1, wherein each of the plurality of DC/DC converters comprises a switching circuit operable to receive the one of the plurality of direct input voltages and a primary winding coupled to the switching circuit; and
wherein the converter arrangement further comprises a secondary winding inductively coupled with each of the primary windings of each of the plurality of DC/DC converters and a rectifier circuit coupled to the secondary winding and configured to generate the output voltage of the converter arrangement.

18. A method, comprising:
receiving one of a plurality of direct input voltages by each of a plurality of DC/DC converters of a DC/DC stage; and
generating, by the DC/DC stage, an output voltage from the plurality of direct input voltages.

19. The method of claim 18, wherein generating the output voltage comprises generating, in combination by the plurality of DC/DC converters, the output voltage of the DC/DC stage.

20. The method of claim 18, wherein receiving one of a plurality of substantially direct input voltages comprises receiving, by each of the plurality of DC/DC converters, the direct input voltages that are based on a portion of an input voltage of a converter arrangement that comprises the DC/DC stage.

21. The method of claim 18, wherein the plurality of direct input voltages comprise one or more of a plurality of substantially direct current (DC) input voltages and a plurality of substantially direct voltage input voltages.

22. The method of claim 18, further comprising:
receiving an alternating input voltage by an AC/DC stage; and
outputting the plurality of direct input voltages by the AC/DC stage based on the received alternating input voltage.

23. The method of claim 22, further comprising:
receiving the alternating input voltage by an AC/DC converter of the AC/DC stage;
outputting a substantially direct intermediate voltage by the AC/DC converter;
receiving the direct intermediate voltage by a series circuit comprising a plurality of capacitive storage elements connected in series; and
outputting one of the plurality of direct input voltages by each of the plurality of capacitive storage elements.

24. The method of claim 23, further comprising:
receiving an input current by the AC/DC converter; and
controlling a phase difference between the input current and the alternating input voltage.

25. The method of claim 24, wherein the phase difference is controlled to be substantially constant.

26. The method of claim 22, further comprising:
receiving the alternating input voltage by a rectifier of the AC/DC stage;
outputting a rectified input voltage by the rectifier;
receiving the rectified input voltage by a series circuit comprising a plurality of voltage converters connected in series; and
outputting one of the plurality of direct input voltages by each of the voltage converters.

27. The method of claim 26, wherein the plurality of voltage converters comprise AC/DC converters.

28. The method of claim 22, further comprising:
receiving the alternating input voltage by a series circuit comprising a plurality of AC/DC converters connected in series; and
outputting one of the plurality of direct input voltages by each of the plurality of AC/DC converters.

29. The method of claim 28, further comprising:
operating one of the plurality of AC/DC converters as a master AC/DC converter such that the master AC/DC converter receives an input current and controls a phase difference between the input current and the alternating input voltage; and
operating each of the other AC/DC converters of the plurality of AC/DC converters as slave AC/DC converters that are configured to receive one of the plurality of direct input voltages by each of the slave AC/DC converters, and control a voltage level of the respective received direct input voltage.

30. The method of claim 29, further comprising controlling, by the master AC/DC converter, the phase difference between the input current and the alternating input voltage to be substantially constant.

31. The method of claim 18, further comprising receiving the one of the plurality of direct input voltages by a switching circuit of each of the plurality of DC/DC converters coupled to a primary winding of a transformer, wherein a secondary winding of the transformer is coupled to a rectifier circuit with an output coupled to an output of a converter arrangement comprising the DC/DC stage.

32. The method of claim 31, further comprising:
operating one of the plurality of DC/DC converters a master DC/DC converter; and
controlling, with the master DC/DC converter, a voltage level at the output of the converter arrangement.

33. The method of claim 18, wherein each of the plurality of DC/DC converters is implemented with at least one topology selected from the group consisting of:
a phase-shift ZVS converter topology;
a TTF converter topology; and
an LLC converter topology.

34. The method of claim 18, wherein the plurality of DC/DC converters each comprise a switching circuit operable to receive the one of the plurality of direct input voltages and a primary winding coupled to the switching circuit; and
wherein the DC/DC converters are coupled such that a secondary winding is inductively coupled with each of the primary windings of each of the plurality of DC/DC converters; and
wherein the method further comprises using a rectifier circuit that is coupled to the secondary winding to generate the output voltage of the converter arrangement.

35. A converter arrangement, comprising:
means for receiving one of a plurality of substantially direct input voltages by each of a plurality of DC/DC converters of a DC/DC stage; and
means for generating, by the DC/DC stage, an output voltage from the plurality of direct input voltages.
